(19) United States
(12) Patent Application Publication
(10) Pub. No.: US 2004/0233237 A1
(43) Pub. Date: Nov. 25, 2004

(54) Development environment for DSP

(76) Inventor: Andreas Randow, Cambridge, MA (US)

Correspondence Address: PHILIP KOENIG, P.O. BOX 980, WINCHESTER, MA, 01890, US

(21) Appl. No.: 10/764,690

(22) Filed: Jan. 26, 2004

Related U.S. Application Data
(60) Provisional application No. 60/442,322, filed on Jan. 24, 2003.

(51) Int. Cl. G09G 5/00; G06F 13/00; G06F 9/46

(52) U.S. Cl. 345/763; 717/109; 717/113; 719/328

(57) ABSTRACT

There is provided a graphical development environment for digital signal processing applications (DSP). The DSP development environment is hosted by a Windows-based application builder and provides tools whereby a user lacking DSP programming knowledge may select and configure DSP functions using standard Windows drag and drop mechanisms to manipulate icons representing DSP functions, and to open and configure property pages associated with each DSP function. User selection and configuration information is used to generate descriptors for use in constructing DSP operating system modules constructed from pre-compiled binary code corresponding to the user selected and configured DSP functions.

### RELATED APPLICATION

Certain aspects of the present application claims priority from Provisional Application for Patent Ser. No. 60/442,322 filed Jan. 24, 2003, and entitled Subject-Oriented Software Development System for DSP.

### FIELD OF THE INVENTION

The invention is directed to graphical software development environments, and more particularly to a graphical development environment for the development of software to control digital signal processing (DSP) hardware devices.

### BACKGROUND OF THE INVENTION

Data acquisition for real-time applications on a DSP board is an engineering challenge. Currently DSP engineers can take up to a year, or more, to develop a C++ program to program a DSP device. End users with limited programming skills cannot take advantage of the strength of DSP functionality, while DSP programmers cannot satisfy the time-to-market requirements of their customers.

A great need therefore exists for a rapid development system for DSP applications, and in particular for a DSP programming environment that does not require the user/programmer to be steeped in specialized programming languages such as TI Code Composer (a DSP programming language created by Texas Instruments and the primary programming language currently employed for the programming of DSP operating systems).

In addition a need exists to integrate a DSP programming environment with existing rapid development environments for test and measurement application software, such as the Measure Foundry development environment system marketed by Data Translation, Inc. of Marlboro, Mass.

### SUMMARY OF THE INVENTION

The present invention (sometimes called OpenDSP) is directed to the creation of capability, for inclusion within a Windows-based rapid development system such as the Measure Foundry software marketed by Data Translation, Inc., of means for creating both a host application and a DSP application, using the same programming approaches and types of tools already provided by the host application.

In the system of the invention, no DSP programming knowledge is required on the part of the end user in order to develop a complex DSP application, including the development of custom DSP algorithms unique and specific to the end user's project.

The system of the invention is based on two major components, a “subject-oriented” DSP operating system and a Windows®-based rapid software development system for test and measurement applications. In this system a user is not required to have any programming skills, as the system uses standard Windows “drag and drop” techniques and one graphical user interface is used to develop both Windows applications and DSP applications.

A central aspect of the programming approach employed in the method and system of the invention is the use of libraries of pre-compiled binaries that represent a large set of DSP functions, such binaries being stored as function panels within a DSP operating system that is an integral part of the system of the invention.

Thus, a DSP operating system is created that contains a set of functions, called DSP panels, that include for example such functions as FFT (Fast Fourier Transform), FIR Filter, etc. To interface with these DSP panel functions, the host application is enabled to create a representative virtual instrumentation panel for each DSP panel, having properties adapted to deal with the associated DSP panel; these DSP representation panels can then be handled by a user of a host application, such as Data Translation Measure Foundry, like standard Measure Foundry panels. (The Measure Foundry development environment, its architecture and its operation are fully described in co-pending patent application Ser. No. 10/230,412 which is incorporated herein in its entirety).

In the preferred system of the invention the Windows-based software development system acts as the interface to the DSP operating system: it browses a catalog of available DSP functions located on the DSP, using the standard communications format extensible Markup Language (XML) and then creates representative function panels for each component of the DSP library, which, when selected, appear as standard panels in the graphical user interface.

When such a panel is opened, a generic property page is created which lets the user set up the properties of the represented function, using simple property editor tools. To enable this process, each component of a target DSP device has an entry in the XML- based description catalog of the DSP function libraries. Once these property pages have been configured with values and parameters, the resulting file is saved in memory on the host, to be sent as a memory block to the DSP in a stream.

The Windows-based host application provides a special container panel, here called a DSP Group Box, for each separate DSP task to be programmed. DSP functions are placed within a DSP Group Box container, and configured, and an Aspect Interaction Language (AIL) file is created, containing descriptors of the selected functions and their configured properties. This AIL file information describes the programmed task, including process ID, used pipes and variables, needed resources, used function objects and their properties, interconnections between function objects and memory consumption.

Utilities are provided to parse the AIL file and translates its contents to a DSP-readable form, and to configure the file into parameters of binary DSP modules, utilizing libraries of DSP executable binaries stored as function panels. The task-oriented, custom DSP Operating System thus created by the user, employing solely the graphical programming environment of the host application, is then ready to be loaded onto the DSP device, and executed.

### DESCRIPTION OF DRAWINGS

FIG. 1 illustrates the interaction of the development environment and a DSP device

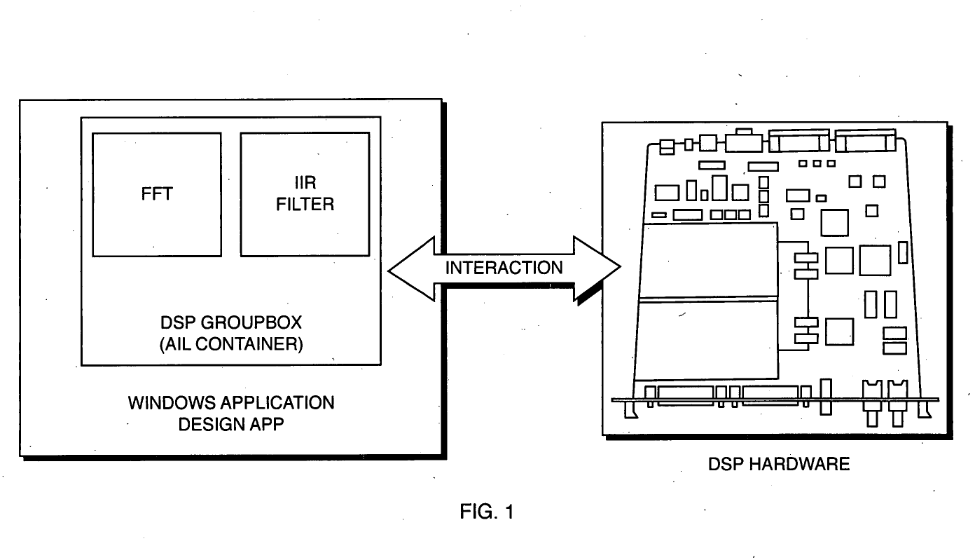

FIG. 2 illustrates potential relationships of the development environment to third party APIs.

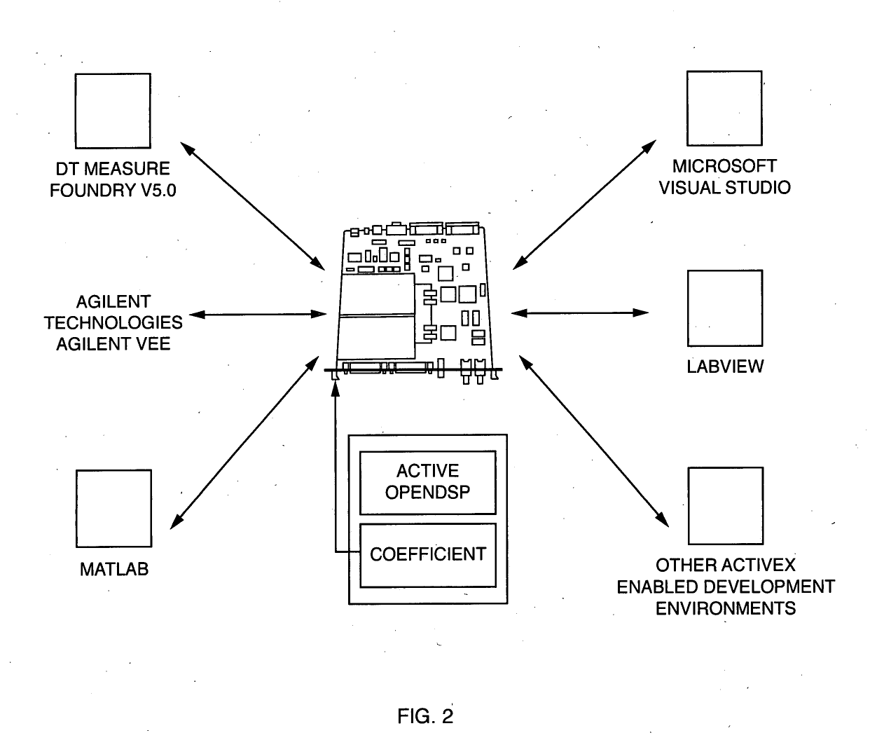

FIG. 3 illustrates the relationship between the DSP operating system and the graphical user interface.

FIG. 4 is a diagram illustrating principal components of the system of the invention.

FIG. 5 is a diagram illustrating the start procedure initiated by a user.

FIG. 6 is a diagram illustrating a user placing a DSP function panel in a Group Box.

FIG. 7 is a diagram illustrating the opening of a DSP function panel property page.

FIG. 8 is a diagram illustrating a sending of configuration data to the DSP component.

FIG. 9 is a diagram illustrating the placing of a second DSP panel into a Group Box.

FIG. 10 is a diagram illustrating the placing of a standard Measure Foundry panel on a worksheet also comprising a DSP Group Box and DSP panels.

FIG. 11 is a diagram illustrating the interconnection of a DSP function panel and a standard Measure Foundry panel on a Measure Foundry worksheet

FIG. 12 is a diagram illustrating the operational interrelationship of a DSP Group Box and a standard Measure Foundry panel.

FIG. 13 is a diagram illustrating the steps to build a custom DSP operating system.

FIG. 14 is a diagram illustrating in more detail steps to build a custom DSP OS.

FIG. 15 is a diagram illustrating steps to build a custom DSP OS, and the file set of the Custom Function File Set.

FIG. 16 is a diagram illustrating the “base function library” backend component.

FIG. 17 is a diagram illustrating the API interface backend component.

FIG. 18 is a diagram illustrating the “dynamic function library” backend component.

FIG. 19 is a diagram illustrating the “base Aspect Interaction Runtime” backend component.

### DETAILED DESCRIPTION OF PREFERRED EMBODIMENTS OF THE INVENTION

A central aspect of the programming approach employed in the method and system of the invention is the use of libraries of pre-compiled binaries that represent a large set of DSP functions, such binaries being stored as function panels within a DSP operating system that is an integral part of the system of the invention.

Thus, a DSP operating system is created that contains a set of functions, called DSP panels, that include for example such functions as FFT (Fast Fourier Transform), FIR Filter, etc. To interface with these DSP panel functions, the host application (Data Translation Measure Foundry in the illustrative example of the preferred embodiment) is enabled to create a representative virtual instrumentation panel for each DSP panel, having properties adapted to deal with the associated DSP panel, and these DSP representation panels can then be handled by the user like standard Measure Foundry panels. (The Measure Foundry architecture and its operation are fully described in co-pending patent application Ser. No. 10/230,412 which is incorporated herein in its entirety).

DSP panels as created within a host application such as Measure Foundry are provided in the present invention with generic property pages, and such DSP panels may be configured by the user through selections of variables as displayed on the generic property page of each DSP panel.

The invention provides for the creation, on a development desktop such as a Measure Foundry worksheet, of an object, herein called a DSP Group Box, to represent each individual DSP task. Within a DSP Group Box, one or more DSP panels may be placed, to represent the various functions necessary to implement the task represented by the DSP Group Box, in a manner that will be made clear below.

As is true of configuration files employed generally in Measure Foundry, the configuration files associated with DSP panels are formatted as “aspect interaction language” (AIL) files; the use of AIL files in the manner described in detail in the above-referenced pending patent application Ser. No. 10/230,412 enables very rapid execution of user-designed virtual instrumentation schemes.

As described in said pending patent application Ser. No. 10/230,412, there is known to develop a Windows-based “virtual instrumentation” application, that enables panels to be created to represent [or contain] virtual instruments such as dials, oscilloscopes, etc. In the present invention, which is an extension of the development system described in the '412 patent application, provision is made for the inclusion, within an application such as Measure Foundry, of a new local panel dedicated to interfacing with a DSP device. In the preferred embodiment illustrated in the drawings, this new local panel is termed a DSP Group Box.

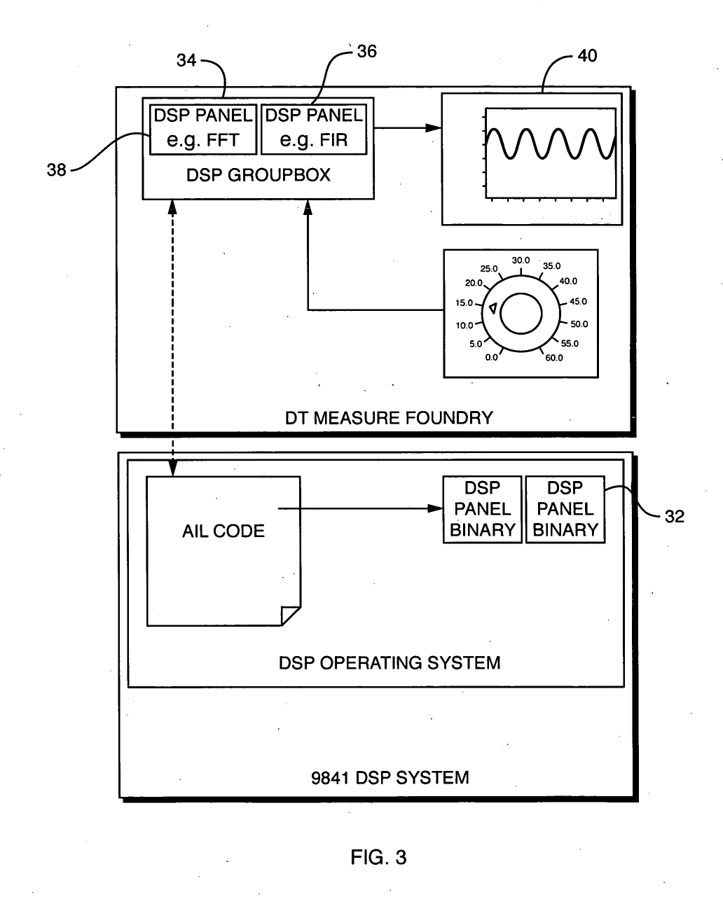

This new “DSP Group Box” panel uses the same programming technology as is used for programming all of the other panels in Measure Foundry; for example the user may place special “DSP panels” on a DSP group box. Accordingly a DSP Group Box is not merely a frame, but rather it is a container adapted to contain, for example as shown in FIG. 3, which depicts a Group Box 36, an FIR filter panel 36, an FFT panel 38, or any of many other kinds of DSP related programming algorithms.

In general, the programming environment used to program the DSP application is the same as is used to program a Windows application, modified to provide for the combination or interaction of a DSP device with the host Windows application. Thus, using the present invention, data obtained from the DSP system, and calculated on the DSP system, may be transferred to the host system (here, Measure Foundry) and there displayed on any panel created in Measure Foundry that is appropriate for the display of such data, such as oscilloscope 40 on FIG. 3. Furthermore, the creation and configuration of panels required to effect this result requires no knowledge of conventional DSP programming, or in fact any DSP programming whatever.

The DSP Group Box is designed to incorporate function panels adapted to DSP devices and their modules. Thus, where a standard Measure Foundry application will comprise panels that may include, for example, dials, oscilloscopes, counters, etc., a DSP Group Box created within Measure Foundry will comprise special function panels created using TI Code Composer. Because an application such as Measure Foundry is not adapted to accept objects created using the TI Code Composer code conventions, any attempt to insert such DSP function panels directly onto the Measure Foundry desktop would fail. Within Measure Foundry, the DSP panels may only be accepted by the DSP Group Box.

As designed to operate with a DSP device such as the Data Translation DSP 9841 device, a DSP development environment according to the present invention comprises a DSP operating system. As illustrated in FIG. 3, this DSP operating system consists of DSP panels 32 stored in binary, which have been pre-compiled for the user. Thus an algorithm, for example an FFT (Fast Fourier Transform), has been fully programmed, and this FFT algorithm makes use of all of the data paths of the DSP device, and as a result the data paths in the DSP system are completely independent of the data paths in the host (Measure Foundry) system.

The interface between the two systems, the DSP system and the Measure Foundry system, is the DSP Group Box that is displayed on the Measure Foundry desktop. That means that the DSP operating system “talks” directly to the DSP Group Box on the Measure Foundry desktop, and the DSP panels and other objects displayed within the DSP Group Box are in effect graphical representations of communications taking place between the DSP operating system and the code that underlies the DSP Group Box.

Measure Foundry creates a representative panel for each DSP panel to deal with appropriate functionalities. The user can actually drag and drop, into the DSP Group Box container, objects that represent a DSP function and that in fact serve as the user interface for programming attributes of the selected DSP function. Thus, when the user double-clicks a panel within the DSP Group Box, a generic property page associated with the selected panel opens, enabling the user to configure all of the attributes appropriate to the function represented by the selected panel. With these actions the user is actually invoking the actions of the DSP operating system necessary to implementing the user's intentions.

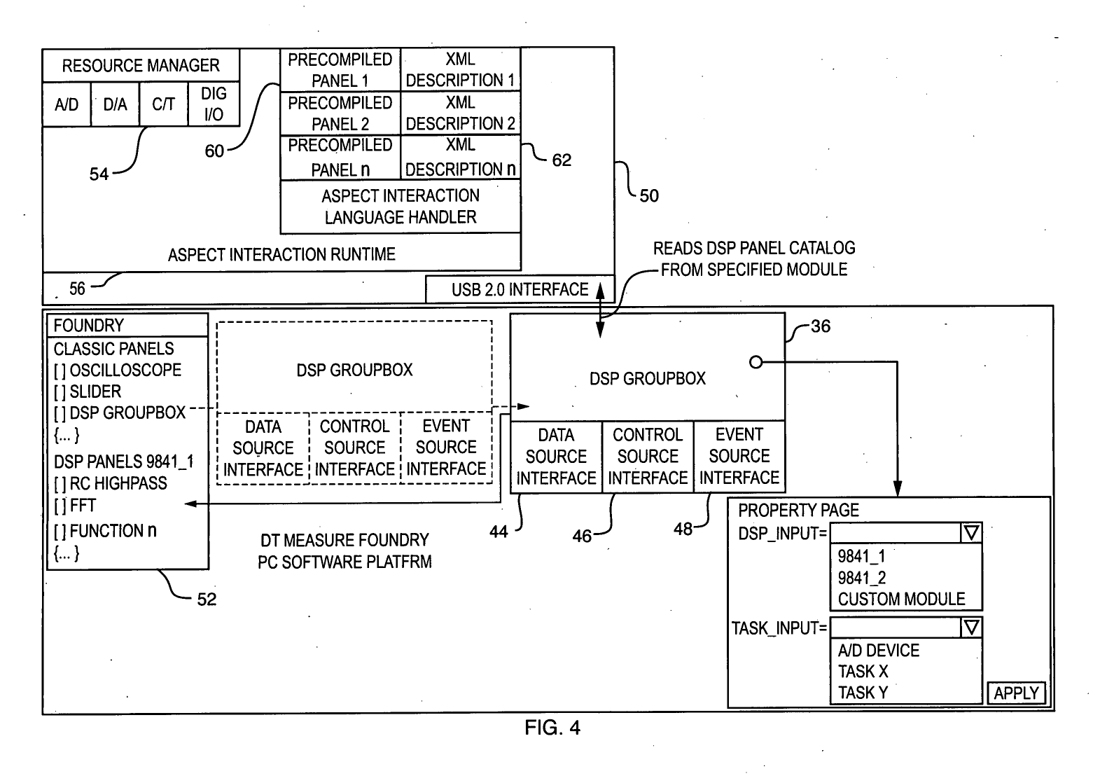

These relationships are illustrated in FIG. 4. Group Box 44 is there shown having Data Source interface 44, Control Source interface 46, and Event Source 48; Group Box 36 is listed on Measure Foundry list of panels 52, that may be selected by a user, and that also includes “standard” Measure Foundry panels such as Oscilloscope, Slider, etc. As shown on FIG. 4, backend “DSP-side” components include Resource Manager 54, “Aspect Interaction Runtime” 56, and “Aspect Interaction Language Handler 58. AIL Handler 58 operates to “translate” XML language descriptions of DSP functions, as selected and configured by a user, into files of corresponding pre-compiled binary, drawn by the AIL Handler from collections of pre-compiled DSP binary functions stored as binary panels 60, and libraries of associated XML descriptions 62.

For example, assuming a DSP panel to be an FFT function having a buffer pre-set for 1024 entries, and which the user wishes to modify it to accommodate 10k entries, the user, simply by opening the property page on the FFT panel within the DSP Group Box, is able to reconfigure the FFT to employ a buffer size of 10240 entries.

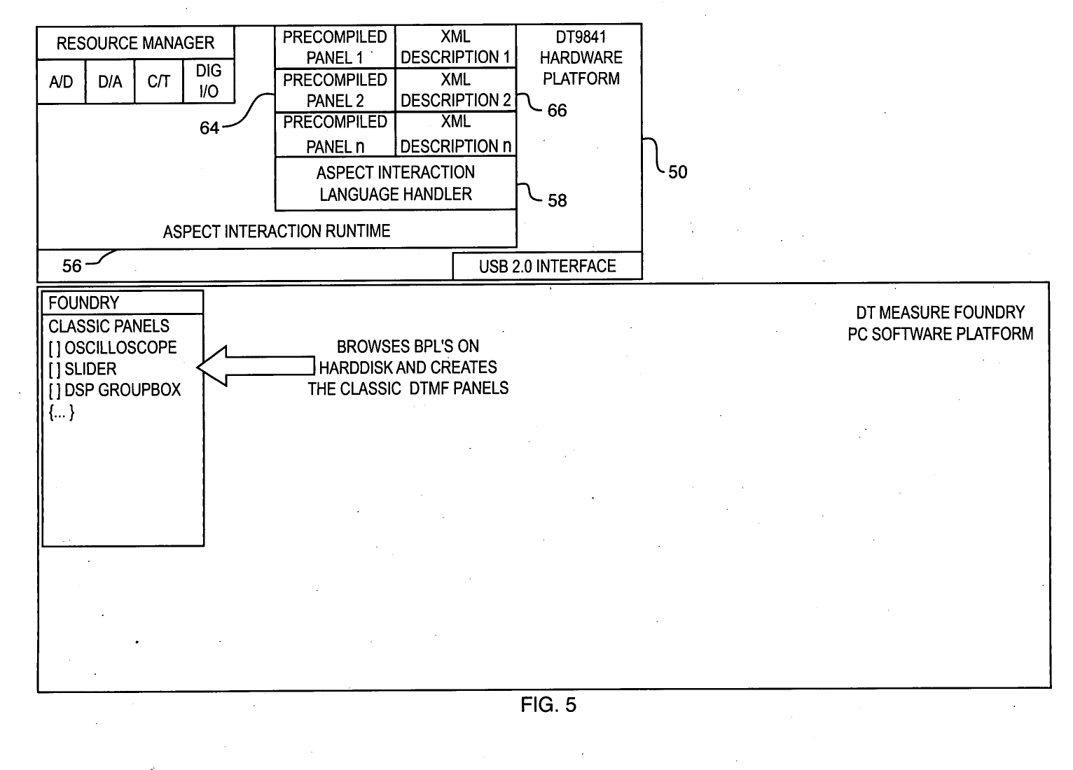

FIG. 5, entitled Measure Foundry “Start Procedure”, shows, on the hardware platform, a block 56 termed the Aspect Interaction Runtime. This term is a working title for the DSP operating system, and it comprises Resource Manager 54 that deals with the subsystems of the DSP system, which may include for example an A/D subsystem, a D/A subsystem, a digital I/O subsystem, a counter/timer subsystem, etc..

Resource Manager 54 consists of code designed to deal with all of the resources provided by a compatible DSP device. The Resource Manager can thus obtain data from an A/D system, or transmit data to a D/A system, obtain data from a counter, or start or stop a counter timer, and generally manage digital I/O events associated with the selected DSP device. Importantly, all of the functions thus made potentially available to the user, through the DSP Group Box panels, have been precompiled in optimized code, and stored in a base function library; for each DSP panel 64 that the user may place in the DSP Group Box and configure, there is an associated XML description 66 that describes all of the pertinent variables, going back and forth between the binary representations resident on the DSP device and the host (here, Measure Foundry) application.

The DSP Operating System contains Aspect Interaction Language Handler 58. AIL Handler 58 runs on the DSP processor and is responsible for receiving and parsing the AIL code that comes from the host: the AIL Handler parses this AIL code, creates the objects that are described in the AIL code, sets their properties, and interconnects them. The object creation and interconnection methods used here are substantially similar to those described in co-pending patent application Ser. No. 10/230,412, reference above.

A Measure Foundry application that comprises the DSP programming capabilities of the present invention is opened in the same manner as a traditional Measure Foundry application. On start-up Measure Foundry browses its local directory, the bin directory, and searches for BPLs (the Delphi programming term for dynamically loadable library of object code, a special form of DLL) that represent available panel libraries. Each panel, notably the traditional Measure Foundry panels, such as an oscilloscope, a slider, but also a DSP Group Box, represents a form of BPL, and each library has one BPL file. When the browser locates such a BPL, it identifies its name, and loads the BPL, thereby making its functionality available to the user of Measure Foundry.

A user of the present invention who wishes to develop a DSP application begins by “grabbing” a DSP Group Box, from a tool listing of available panels, and placing it on a standard Measure Foundry worksheet, using a conventional “drag and drop” action. As illustrated in FIG. 4, the DSP Group Box, upon being “dropped” onto a Measure Foundry worksheet, already comprises fully functional data source interface 44, a control source interface 46, and an event source interface 48. Accordingly, the newly created DSP Group Box has at hand, from the outset, all of the resources it will require in order to communicate with all other components in Measure Foundry, including any other Measure Foundry panel on the worksheet. In particular the DSP Group Box has the resources to effect communications between the Measure Foundry data source interface and the DSP Group Box. At a later stage, described below, the DSP Group Box will also contain the content of a DSP program.

To this point, the procedures followed by the user are identical to the processes previously disclosed, in co-pending patent application Ser. No. 10/230,412, with respect to traditional Measure Foundry activities.

When the user opens the DSP Group Box (by double clicking on the DSP Group Box icon), the user can select the DSP input, which means that the user is to select either a physical DSP device to communicate with the DSP Group Box, or, in the alternative, another DSP Group Box. The physical DSP device may for example be a Data Translation 9841 DSP device, or another DSP device for which the developer of the DSP rapid development environment has made provision, through backend programming substantially identical to that employed to adapt the system to handle DT 9841 activities.

Generally each DSP Group Box represents one DSP task, to be run on that DSP Group Box. Accordingly, where the user's project requires task-to-task communication, for example, a separate DSP Group Box is created and employed to serve as the data source for the other. (It should be kept in mind that the task-to-task communication thus programmed will itself take place entirely on the DSP device, which will send data to the host only when it is needed there). For example, if a user wishes to stream data, say, from an A/D source, and then to perform an FFT analysis on that data, but eliminate from the analysis all data representing frequencies above 20 KHz, then a second DSP Group Box, which is to act as the frequency filter, will be required to communicate with the first DSP Group Box, which acquires the raw A/D data. DSP Group Boxes may thus be “cascaded”, using one DSP Group Box as the data source for a second DSP Group Box.

Upon clicking “Apply”, the DSP Group Box acts upon the user's instruction to communicate with the selected DSP module: assuming, for example, that the user has selected the DSP module representing DSP device 9841-1, which is, say, the first DSP module on the USB bus. Where the DSP Group Box is capable of locating and reading all of the XML descriptions from the library, it can contact the selected DSP module and read all of the pertinent XML descriptions from the DSP module, simply by reading an XML file.

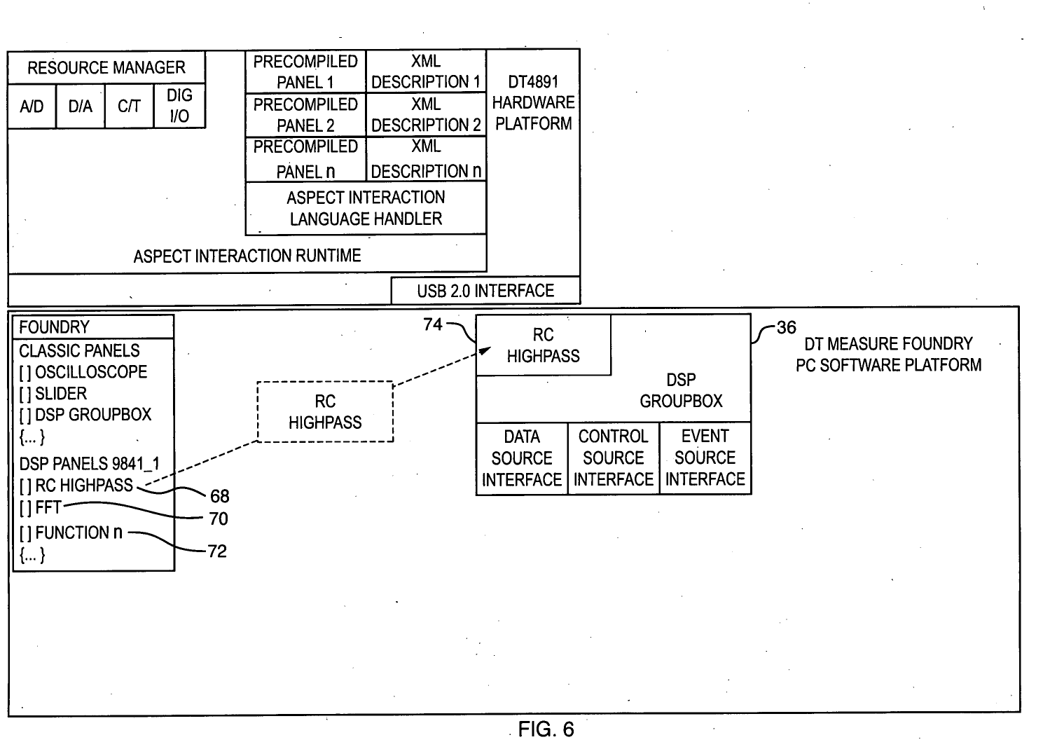

Referring to FIG. 6, it is seen that, by reading all of the XML files, the DSP operating system, here called “Aspect Interaction Runtime”, contains, for example, High Pass 68, FFT function 70, and sample function “n” 72, whatever that may be. However all that is displayed to the user is the name of the task “RC Highpass” on icon 74, and all of the associated variables. For each task name the user creates a virtual DSP panel within DSP Group Box 36, with a virtual or generic bitmap, to represent each of the functions associated with the selected DSP module. It should be noted that these objects, to this point, are purely virtual representations of the DSP module of interest, and contain no programmed code.

In order to use one of the functions that is actually stored in the physical DSP device, a user may for example select the RC High Pass function, upon deciding to use the DT 9841 device as a data source, and use A/D data as a task information. The user then places RC High Pass icon 74 on the DSP Group Box, to process or “pass through” the data received from the 9841 device. (Any attempt to place such an RC High Pass representation of the DSP module directly onto a DT Measure Foundry worksheet would be unsuccessful, as the Measure Foundry standard worksheet is unequipped to accept directly objects such as the DSP panels. Only a DSP Group Box is adapted to accept objects having the properties and attributes of these generic components.

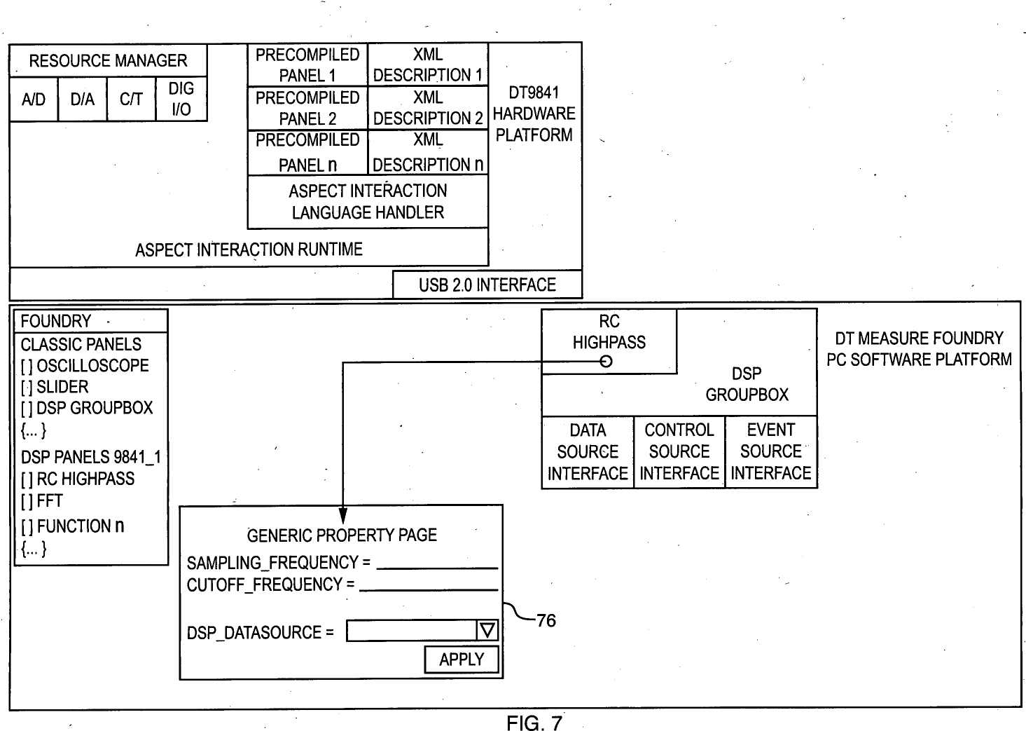

A basic attribute of the generic components from which virtual DSP functions are built is the ability to react to a double-click action by a user. Thus, upon the double-clicking of such a newly placed generic DSP component, that generic component causes generic property page to open, and to display, all of the generic properties of the RC High Pass panel on the DSP Group Box. As shown in FIG. 7, an exemplary tabular display of RC Highpass generic property page 76 might have left column listing property names, and a right column for associated property values.

In the case of an RC High Pass filter, the displayed properties would, for example, set out the various properties, generic to any RC High Pass filter, that the user would need to configure in order to implement the RC High Pass function; these properties would typically include, for example, a cut-off frequency, as well as the selected DSP data source, all as generic properties.

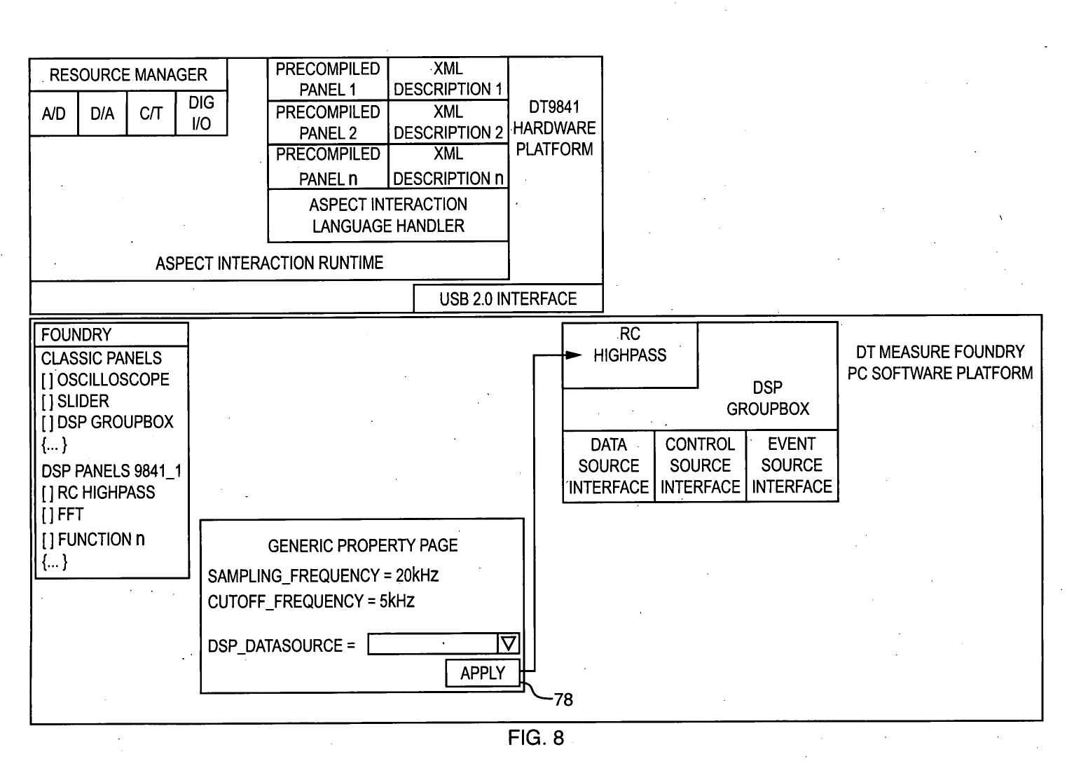

Upon choosing and then setting selected properties by clicking “Apply” button 78, as shown in FIG. 8, the user sets in motion the resources employed for the streaming of data directly to the RC High Pass filter on the DSP Group Box, itself contained on a Measure Foundry worksheet executing on the host computer. To this point in the programming procedure, however, the physical DSP device which is to serve as the data source has had no involvement, except solely as a source of XML descriptors (which contain the generic properties of the physical DSP device and all of its embedded functionality).

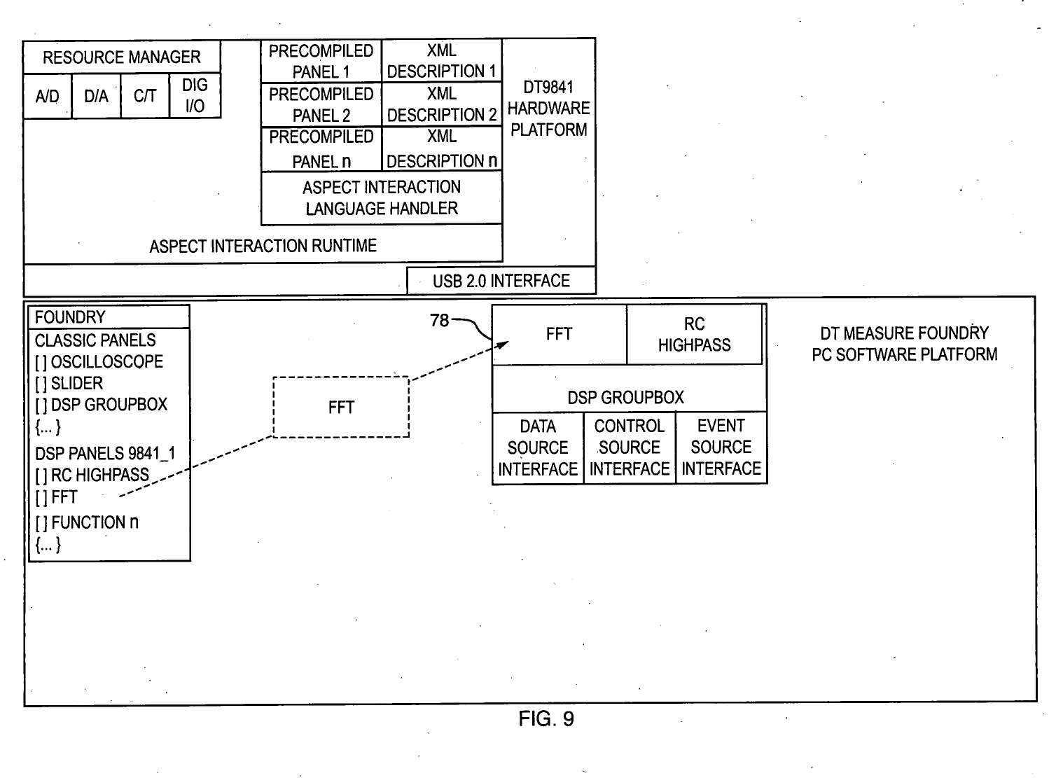

Continuing with the illustrative example of a user who wishes to pass filtered DSP data on to an FFT analyzer, in order to implement this task, the user would be required only to place another DSP panel within the same DSP Group Box that contains the RC High Pass filter. The same graphical programming procedure is employed here as occurred regarding the RC High Pass filter: an FFT panel is placed within the DSP Group Box, as illustrated in FIG. 9, and its property page is opened, displaying suitable means for selecting its set of programmable variables, including for example FFT size, a window function (such as a “Hamming” window or a “Blackman” window). If necessary or useful to the user's project, yet another function, say function “n” may be placed in the same DSP Group Box, for example a function designed by the user from generic components.

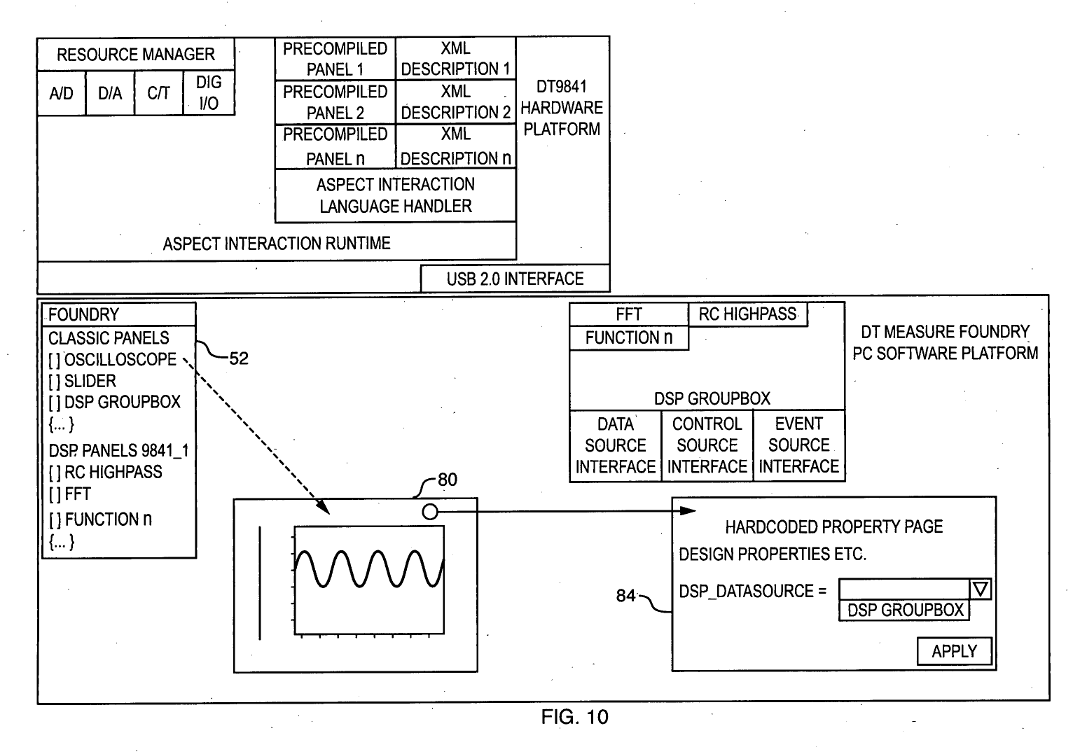

At this point, it becomes necessary to connect the group of DSP functions that we have been discussing with the “classic” DT Measure Foundry application, that is, to enable the means to display, on the Measure Foundry worksheet, DSP data as actually processed in real time through the physical DSP device, and the selected DSP functions. To carry out this task, as illustrated in FIG. 10, the user would for example place, on a standard Measure Foundry worksheet, an oscilloscope panel 80 selected from the library of standard panels provided by Measure Foundry. Opening the “hard-coded” property page 84 of that oscilloscope panel, the user would then select the data source, in this case the DSP Group Box.

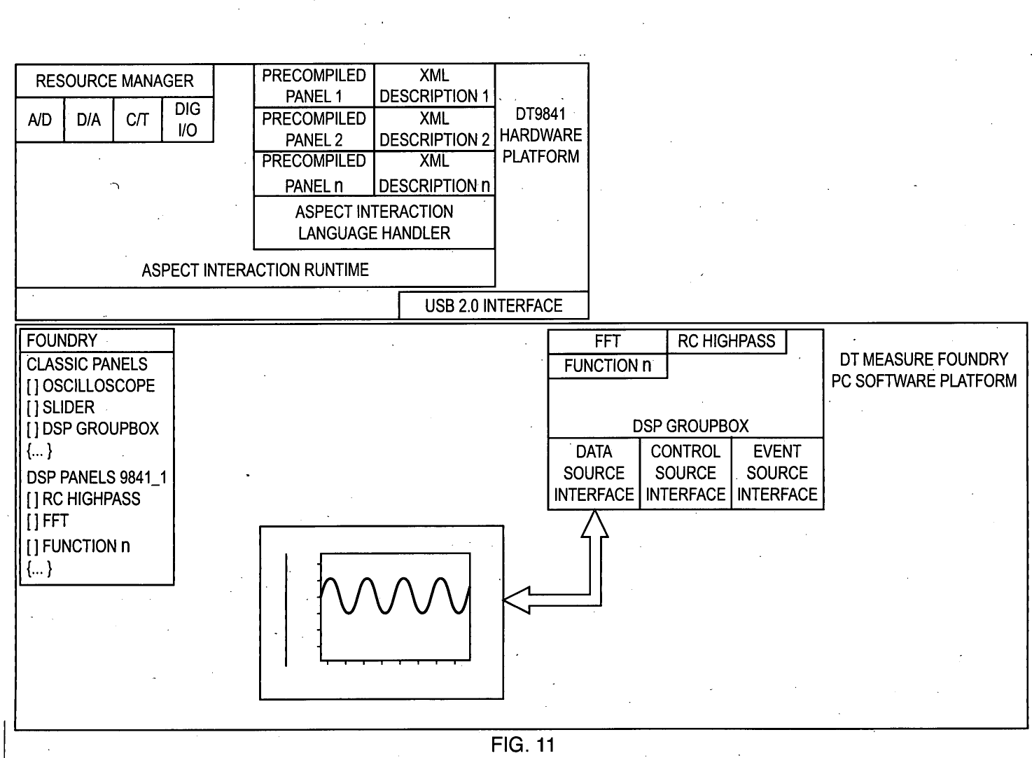

Upon the user clicking “Apply” following the selection of a DSP Group Box as the desired data source for the oscilloscope panel, the data source interface built into the DSP Group Box is enabled to “talk” directly to the oscilloscope panel on the Measure Foundry worksheet, as illustrated on FIG. 11.

It will be recalled that more than one DSP Group Box may be placed on a worksheet. Where that is the case, the user, on opening the “data source” list box on the oscilloscope property page, would be provided with an enumeration of extant DSP Group Boxes, available for use as the data source for the oscilloscope panel.

Upon starting a measurement application, by clicking the start button on the Measure Foundry worksheet (or by clicking “run”), the following actions occur substantially simultaneously:

The DSP Group Box is notified that it must now generate the AIL code corresponding to the library code, that is, code in AIL format that embodies the responses made by the DSP device to the query that was sent to the DSP device upon initially creating the DSP Group Box and associating it with a specific DSP device module.

When the DSP device was initially queried, through the DSP Group Box, and was asked to supply to the DSP Group Box with an identification (a) of the available DSP modules, and (b) the property “fields” associated with each such module, the response of the DSP device in effect consisted of a set of blank forms, setting out fields to be filled out by the user, by the insertion of the user's desired configuration information. The user's configuration instructions may thus be said to constitute the content of the XML library forms obtained “in blank” from the DSP device. Where a number of different modules of the DSP device have been configured by the user, the DSP Group Box now returns to the DSP device, in XML code, the complete set of configuration instructions required to create the objects and the object interconnections that are required by the DSP device in runtime.

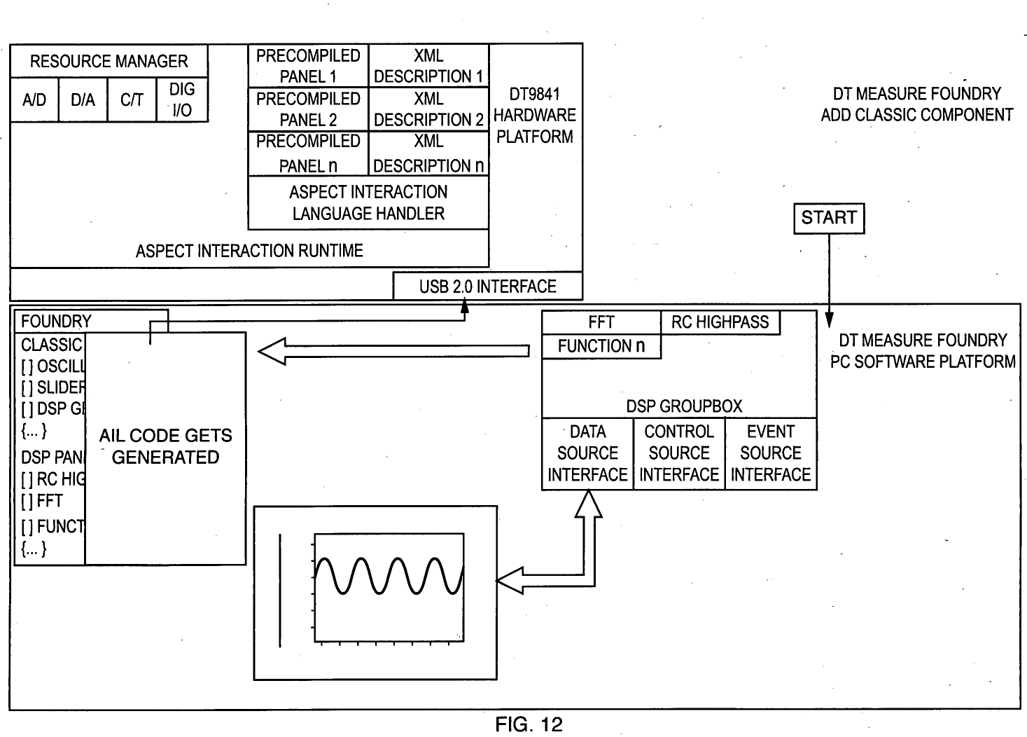

As illustrated in FIG. 12, upon now starting the runtime application, all of the data acquired by the DSP device, and processed by the DSP device in accordance with the configuration instructions programmed by the user as described above, may without any further programming activity be displayed on the standard Measure Foundry panels placed on the worksheet desktop by the user: all of the required data sources and data paths are provided by standard Measure Foundry functions (as set out in co-pending patent application Ser. No. 10/230,412).

Part II. Enabling Extension of the System to Custom User Applications

The invention contemplates that the developer of the system of the invention will have prepared, and coded, for the use customers who are the “end users” of the system, a set of libraries that in the aggregate comprise all of the functions the customer user would require in order to interface the DSP device with a virtual instrumentation system application such as Measure Foundry. Many occasions will still arise, however, in which a customer will want to extend a system like that provided by the invention, as described thus far, to incorporate custom functions and solutions that may be unique to that user and to that user's project. This contingency may be expected in particular with respect to military and national security projects.

For these situations the present invention provides tools that will allow an end-user of the invention to incorporate custom functions that will operate in tandem with the developer-provided functions and tools, to create a complete system. To this end the invention provides for the creation of custom DSP panels, within a DSP Group Box as described above, and it provides a programming tool, the “custom function framework wizard,” for use in configuring the proposed custom DSP panel.

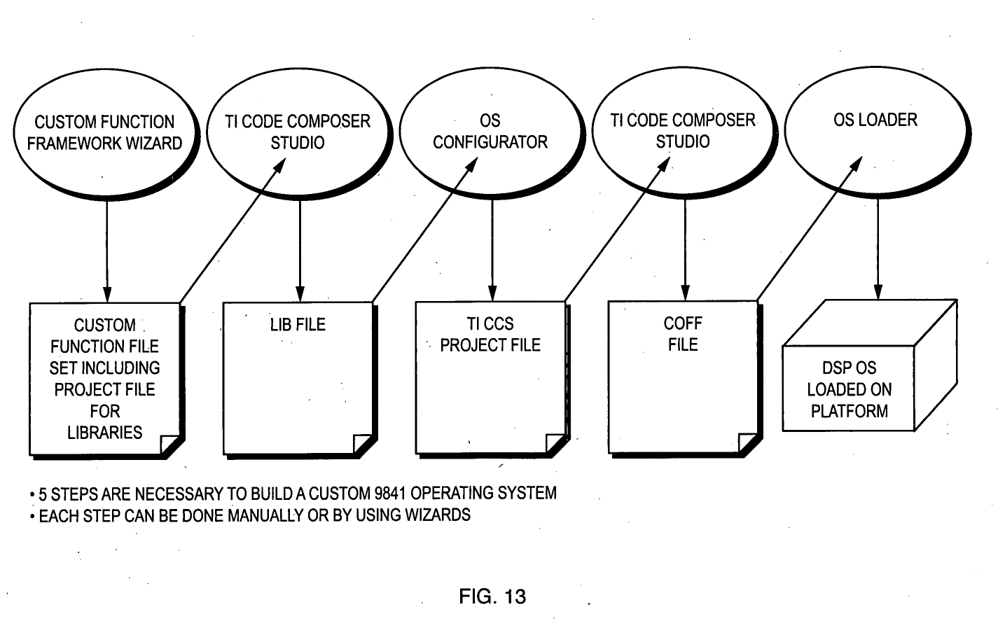

In the preferred embodiment of the invention the Custom Function Framework Wizard is an executable graphical application, in effect a Windows-based application independent of the Measure Foundry application. The five steps required to create a custom DSP operating system, for a DT 9841 DSP device, are outlined in FIG. 13.

Upon opening the Custom Function Framework Wizard, the user is asked by the Wizard to supply a project name, say, “Vibration Analysis I” in the case of a user seeking to develop a vibration analysis algorithm. The user is then asked to specify a local directory on the local hard disk of the user's host computer.

The Wizard next asks the user to specify a panel style, to be placed in the DSP Group Box, taking into account the intended type of function to be implemented: what kind of functional capabilities does the user require? Is it to be simply a data source interface, or does the user require also a control interface? For example, does the user require or desire an interface to an operable slider control, like the standard slider panel provided in Measure Foundry, having the capability to change a variable or even a component in a physical DSP device? Such requirements call for a control source capability.

Where the user's intended task will create events, such as an overflow condition, and it is desired that the occurrence of such an event be reported back to the host, then the programming must incorporate an event capability.

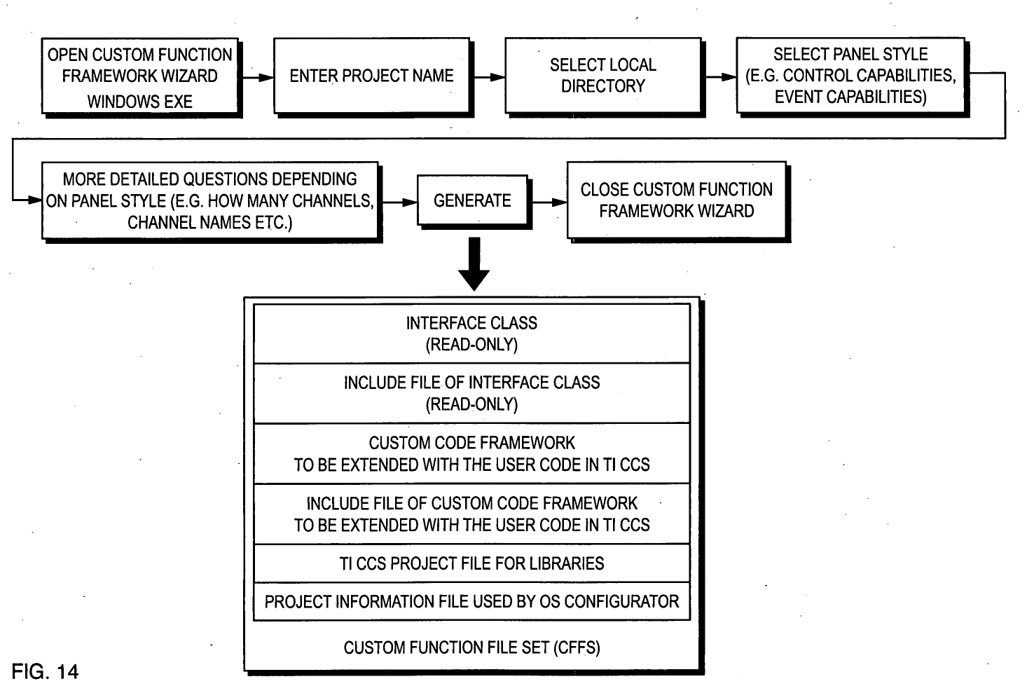

Resources of each of these types, data source, control source, and event, may be incorporated into a DSP panel, as the user selects the functional capabilities to be included in a custom DSP panel. Depending on the panel style selected by the user, additional configuration options are made available to the user by the Custom Function Framework Wizard: detailed queries, appropriate to the pertinent panel style, are proffered to the user: For example, how many channels are desired? What name is to be assigned to each channel? These sequential steps are illustrated in FIG. 14.

Upon completing the configuration of the desired custom DSP panel within the Custom Function Framework Wizard, the user simply clicks the button “Generate”, and the Wizard proceeds to place, within the local directory selected by the user (as set forth above), a set of six files called the Custom Functional File Set (CFFS).

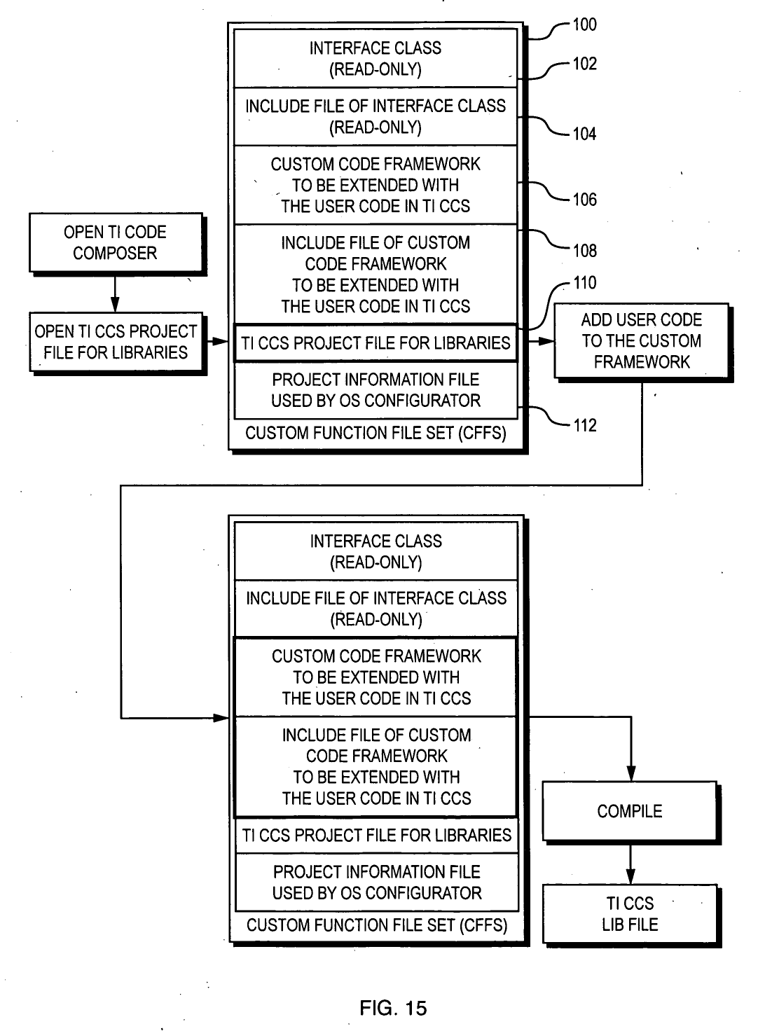

As diagrammed in FIG. 15, the CFFS file set comprises, first, a “read only” interface class 102, and an associated “include” file 104, also “read only”; both of these files are, in the preferred embodiment, written in Standard C/C++. The CFFS file set next includes a Custom Code Framework 106, which is to be extended with the user code discussed above, written for TI Code Composer (a programming language developed by Texas Instruments, and used for programming DSP devices based on Texas Instruments chips); an “include” file 108, associated with the Custom Code Framework file, is the fourth CFFS file.

The fifth file in the CFFS file set is “Project” file for libraries 110, also written for TI CCS, which is to contain a library of TI CCS terms. The sixth and last file in the CFFS set is a Project Information File 112, to be used by an executable file called the OS Configurator, the operation of which is described below.

As illustrated in FIG. 15, at this point the user closes the Custom Function Framework Wizard, all of the six files of the CFFS file set having been placed on the user's local hard disk. Next, the user opens a TI Code Composer application, and, within TI Code Composer, the user opens the Project Files for Libraries file created as described above. In this way, an entire project can be loaded into Code Composer in a manner that requires effectively no Code Composer programming by the user. The entire framework required to design a Code Composer-based programming project has been provided to the user in a graphical environment.

Having opened the Project File for Libraries from the CFFS file set on the local hard disk, the user can then add the user code to the Custom Code Framework provided by the Project File for Libraries. The Custom Code Framework consists of a set of functions with exemplary code content. The user only needs to replace the exemplary code with the real user code, and the user code to be added will generally be present in the Custom Code Framework, having been added by the system developer through an extension of the standard DSP function library. The system developer may either (a) create a custom library and download it separately from the standard DSP Operating System and directly to the DSP, or (b) add the custom DSP functions to the standard DSP Operating System (for example utilizing the OS Configurator to link a new library containing this code into the DSP OS which is then downloaded as one unit into the DSP processor).

The custom code framework thus provided to the end user may be characterized as, in principle, a piece of source code that comprises all of the functions that the user may require, leaving the user with the task simply to specify the functions to be employed in order to implement the desired custom algorithm: the data to be used is already there, in a ready-to-use format, adapted to the potential needs of the user. Accordingly the user need not be concerned with such issues as compatibility of variable types, array types, etc. The user can simply loop through this data, using for example a for-loop, and proceed to edit the custom framework with the user's own additional code. Having done so, the user clicks “compile”, and the TI Code Composer application proceeds to compile the complete algorithm, including the custom code added by the user, resulting in a fully compiled Code Composer “Project”, which may be stored as a .lib file.

In accordance with conventional Code Composer procedures, the lib file thus created may be combined with other such .lib files into a Code Composer “Common Object File Format” file (a so-called “COFF” file) that is directly executable by the DSP device processor.

The end user's programming objective may be said to be the creation of a DSP operating system, or an extension to an existing DSP OS already loaded on the DSP device of interest, that is capable of running on a physical DSP device, and that is capable of implementing, on that DSP device, the specific algorithm of interest to the user. To carry out this task it is necessary to employ an application such as an “OS Configurator”, a programming tool that may readily be incorporated into a rapid development application such as Measure Foundry.

Akin to a browser application, the OS Configurator application is capable of browsing through a set of local libraries, seeking out and identifying library files that meet a search criteria, and returning the identity of the located lib files to the user. Preferably, the OS configurator returns its file identification information in a graphical manner, for example in the form of icons, enabling the user to drag and drop selected files into a suitable container object, which is capable of collecting the submitted library information and formatting it into a TI Code Composer “Project File” for use by the operating system of the DSP device.

From within the OS Configurator application, the end user needs to select all of the function libraries containing functions of interest, that are to be combined into one DSP operating system. This combination may consist solely of pre-loaded function libraries provided by the system developer, or it may comprise a combination of system-provided function libraries and of function libraries created by the end user in the manner described above.

To create a Project File, in a TI Code Composer file format usable by the operating system of the intended DSP device, it is thus necessary to use the OS Configurator, to collect all of the functions to be included in the Project File. When all of the desired functions have been collected, they may collectively be “saved” to the local hard disk as a single Code Composer “Project File”, that is to say, a Code Composer .prj file.

In order to convert the .prj Project File into a so-called COFF file that is capable of direct execution by the operating system of the DSP device, it is necessary first to compile the .prj file, a task that is carried out by the Code Composer application. From within Code Composer, all that is required is to open the .prj file that represents the user's intended DSP application, and to click “Compile”. There results a fully compiled COFF file immediately capable of execution by the operating system of the target DSP device. (Alternatively, the prj file could be compiled from a command line; in which case the user would not need to open and utilize TI Code Composer).

The newly created COFF file of the end user's DSP Project File may be tested by opening the OS Loader in Measure Foundry, or a like tool in a comparable application. Alternatively this COFF file may be downloaded to the DSP's Operating System by using the DSP's download utility application. The OS Loader is employed to transmit that COFF file to the DSP device, simply by selecting the appropriate COFF file, and clicking the “Upload” button. With this action the DSP device has been programmed to deliver to the Measure Foundry application the specific data sought by the user, processed as called for by the algorithms specified by the end user.

A COFF file embodying a Project File, and put together from a selection of function libraries, may also be sent as a package to any other host equipped with the DSP development package, and there compiled to operate with a target DSP device, absent any prior communication by that host with the target DSP device. The COFF file thus transmitted contains an XML description of all the capabilities of the contained DSP OS, including all contained (user) functions. These are the XML descriptors that were mentioned above. The XML description is read by the new host, which parses the XML description and derives the available DSP panels from it.

Put another way, the Measure Foundry application or like application on the new host will simply read-out all of the function library information contained in the transmitted COFF file, and proceed to use that information to configure a DSP Group Box application to interface with the target DSP device.

Part III. Backend Components

The following section describes so-called “backend” aspects and components of the invention, including details regarding the interface used to create the function libraries and to provide them as tools and resources to the end user. To meet the objectives of the invention, it is necessary to have available a Framework and an API that readily allows the integration of new (custom) functions. The Framework holds together all functions and presents them to the host application, such as Measure Foundry. The API gives access to the Framework functionality and to the low-level device-dependent functionality. One API is responsible for the DSP side of the Open DSP project and one API is responsible for the host side. Both APIs work together to create a layer of abstraction on top of the standard DSP and Host Communication libraries.

This section also describes how DSP Group Boxes are created, and how the working of the interfaces that effect communications between the DSP Group Box (and its DSP panels) and the standard Measure Foundry application and its standard panels (or a like host side Windows-based development environment application). By setting out the processes for deconstructing the “abstract layers” of the “Open DSP” project and rendering them in the form of an implementation layer; this descriptive material may be characterized as an interface between the abstract layers of Open DSP and its implementation layer.

APIs are often designed for optimal coverage of a known task. However it is commonplace that, after the API has been comprehensively defined, more aspects of the task or even new tasks appear, and the API is required to be extended. This usually means that larger parts of the API must be adapted. In the case of layered APIs this can mean that, to add one feature, changes must be made in several layers. The task of modification is event more complex where different hardware devices need to be accessed through the same API. In such cases, extending the API for one specific hardware device or type usually requires that similar changes be carried out for all hardware drivers.

The present invention avoids this dilemma, by disclosing an API that does not define any specific features but only common behavior. Using this API, extending functionality does not involve any changes in the common behavior or in the API itself. The present invention combines a number of advantageous provides a number of features. It comprises a light-weight API, in which a few functions suffice to provide all the needed functionality. The API has an open, extendable interface, such that functionality can be added without changing the API.

The API is designed to be implemented on an ActiveX host interface, preferably .NET interoperable. An easy-to-use interface, and a Code Assistant feature, for accessing and modifying the firmware, enable rapid coding of extensions. The API employs a Configurable Property cache that helps reduce traffic. Other features include use of a dynamic property namespace, a hierarchical namespace, and data link capability in the DSP connectivity interface.

The Open DSP architecture uses only unspecific information. No property, data path or event is special or predefined in any way. The single defining instance is the DSP kernel, which defines all properties, data and event paths. The API only provides a framework for defining these attributes and for accessing them.

Some interfaces in the preferred API of the invention use XML code for universal descriptions. In this preferred embodiment, XML code is used internally to transport property data between the host and the DSP device. Other transport mechanisms also use XML code to describe their content. XML (or “extensible markup language”) is an open standard for describing data. XML uses a tag structure similar to that of HTML, a conventional web page format protocol; however, where HTML only defines how elements may be displayed on a page, XML defines what those elements contain. XML permits virtually any data items to be identified readily.

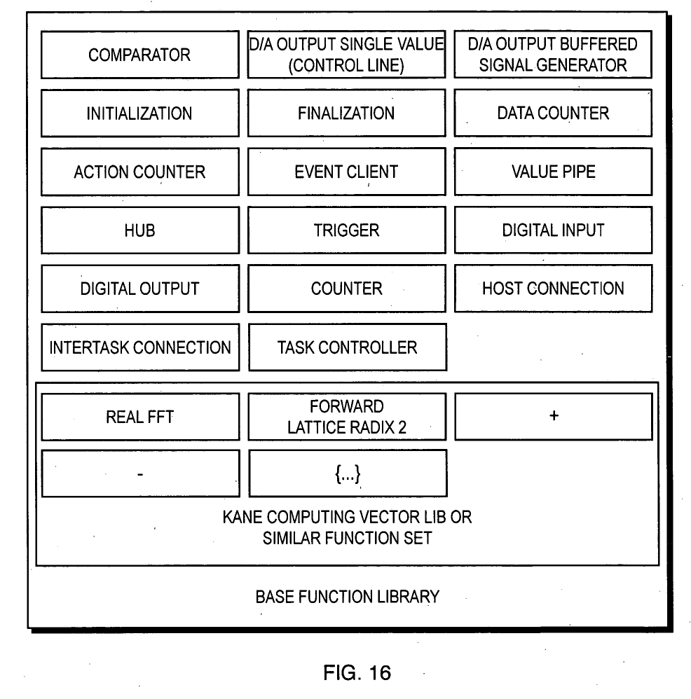

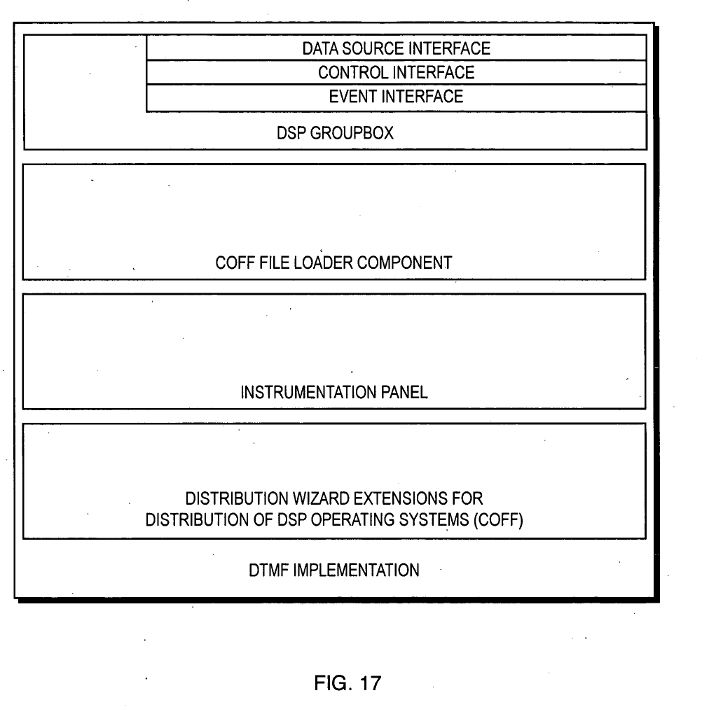

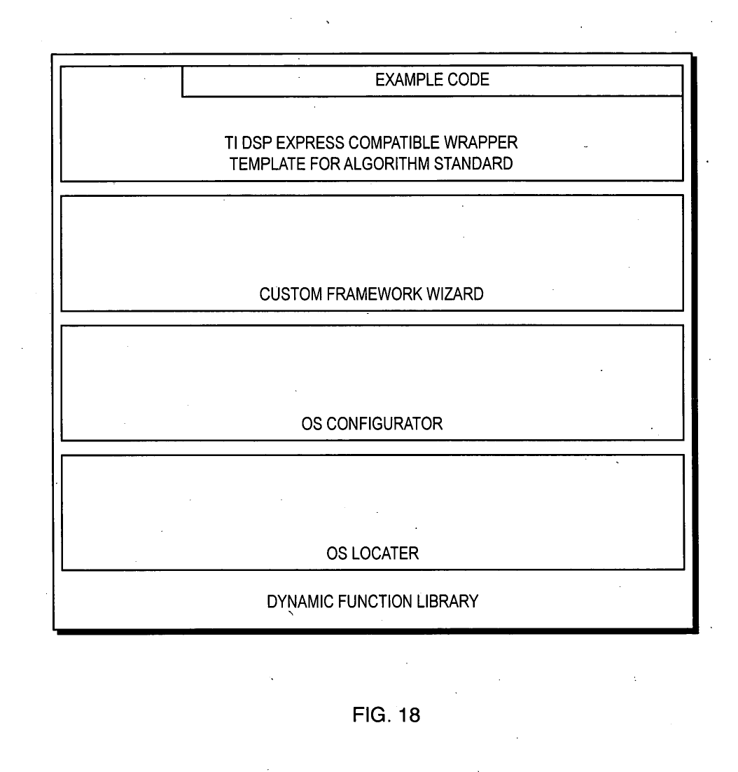

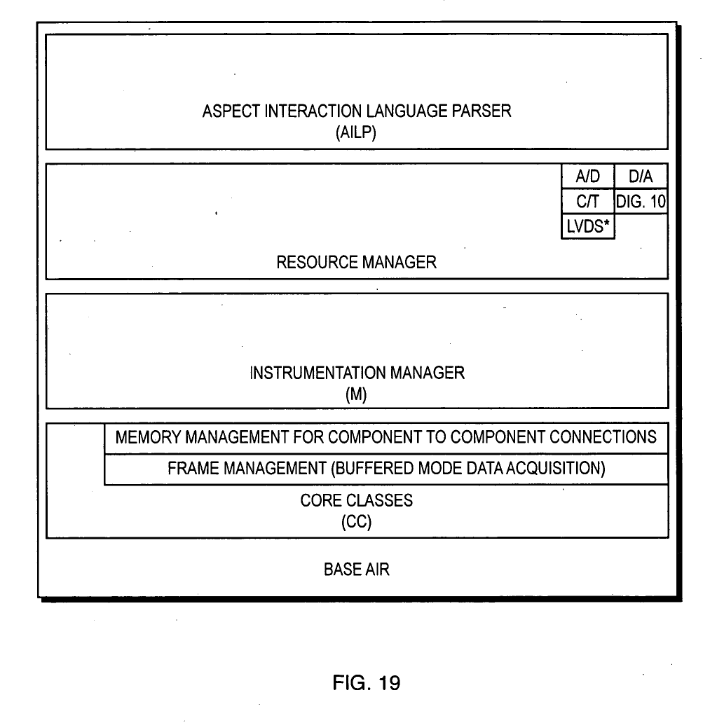

The backend components of the development environment of the present invention may be divided into four main groups, as follows: A “base function library” illustrated in FIG. 16, comprises the libraries of pre-compiled binary DSP functions. An interface implementation module, illustrated in FIG. 17, handles communications with the host application. A dynamic function library, illustrated in FIG. 18, comprises utilities for developing custom DSP applications, and for loading the DSP Operating System onto the DSP device. The fourth component, here called the “Base AIR” component, is illustrated in FIG. 19, and it comprises the components responsible for translating, into pre-compiled binaries “understandable” by the DSP processor, the configured function descriptions generated by user of the development environment.

API-Side Architecture

The API of the present invention comprises five functional units, as follows:

API and board management interface

A Property handling interface

A Data reception interface

Event reception interface

Data sink interface, to transport data from host to DSP more rapidly than through the property interface

API and Board Management Interface

An API and board management interface is responsible for performing such tasks as enumerating available DSP boards, connecting to a specific DSP board and loading specific DSP kernels into a selected DSP device.

Property Handling Interface

It is a central aspect of the architecture of the system of the present invention that all properties that are required to be configured in order to carry out a DSP task are defined by the DSP kernel, which is accessed through a DSP kernel connectivity interface. Internally, XML code is used to transport property data between the host API and the DSP.device.

A property handling interface, resident on the host API, provides functions to enumerate all defined properties, to get and to set their values and to get their possible enumerated values (if they are defined as enumerated properties). A property is an attribute that has a well defined data type and name. Optionally it may define a definition range, a description and other additional information. This information is provided to the host API as XML code. XML tag identifiers are not case sensitive, and XML tags are by definition extendable. Thus, if there needs to be a new custom-defined extra information for a property, it can be added without changing any of the API calls or interfaces. (To assist the programmer, support functions as described below are provided that serve to isolate tags from the XML code and to decode the enumeration and range tags.)

As used in the present invention, the property name space is dynamic, which enables the system to adapt to changes in the configuration of devices. This means that the namespace is defined at some point and that it may change afterwards. Whenever the namespace changes, for example upon a user action creating new data sources and generally upon the addition or removal of properties, a namespace changed event is sent that informs the host of the change in the namespace. The application can react to this event by reading the property definitions again. Preferably, all property methods are blocking. That is, each waits until the called operation has completed before returning.

Property Caching

The preferred embodiment of the invention makes available a property cache mode, the purpose which is to reduce the amount of DSP interactions in order to speed up operations. In property cache mode, all properties can be read at once into an internal cache. In that case, all accesses to properties only access the cache, and changes are made to the cache only. A method, here called FlushPropertyCache, sends all changes made to properties at once to the DSP device. Another method, herein called UpdatePropertyCache, reads all properties from the DSP device into the cache. A third method, SetPropertyCacheMode, enables or disables property caching. Writes to the cache are stored as property value XML code. The codes are collected and sent collectively when the UpdatePropertyCache method is called. Writes to the cache also change the read cache if it were enabled. Note that the namespace may change due to changes in properties. If such a change in namespace occurs, the cache is reloaded automatically from DSP.

Internal Property Representation

There are two internal representations of a property. One is used to define a property and one is used to get/set values of a property.

The Property Definition Representation.

Property definitions as used in the present invention are formatted in pure XML code. Certain essential XML tags must be present in all property definitions. These are:

<PropertyDefinition> wraps a property definition

<Name> specifies the name of the property. This must be unique and should be grouped into logical clusters like this “A/D.Clock Frequency”.

<DataType> the data type of this property . . . Possible data types today are “integer”, “float”, “string”, “enumeration” and “array of integer”, “array of float”, “array of string” and “array of enumeration”. These types can be extended in the future if needed.

<Enumeration> this tag is mandatory if the DataType is _{“}enumeration”. It enumerates all possible values for the property. Every value is a string constant like “_{“}Internal trigger”.

Other XML tags are optional but have predefined meaning:

<Description> this tag describes the property in a few words it can be used as an online help if the application supports this. This tag should be used but it is not mandatory.

<Range> this tag defines a range of allowed values. For example the property “D/A.ChannelO.Value” may have a value range of −10 . . . 10, because this is what the converter can deliver.

Still other XML tags can be added as needed. There is no restriction on the number of additional tags used. (Of course any such additional tags need to be capable of recognition by an associated application software to be of any use). The following illustrates a property as defined using XML code (indentations are shown for better visibility, and need not appear in the final code):

```
<PropertyDefinition>
<Name>
somepropertyname
</Name>
<DataType>
float
</DataType>
[optional code
<Description>
  This property is used as an example...
</Description>
<Range>
  <Min>
    −10.0
  </Min>
  <Max>
10.0
  </Max>
  <Step>
    1.0
  </Step>
</Range>
<Enumeration>
  <Item>
    <Value>
      Internal trigger
      </Value>
      <Description>
        Sets triggering to intenal trigger source...
      </Description>
  </Item>
  <Item>
    <Value>
      External trigger
    </Value>
    <Description>
      Set trigger to an external trigger source
    </Description>
    <Item>
  </Enumeration>
  <AnyOtherTa
    blablabla
  </AnyOtherTag>
end of the optional code]
</PropertyDefinition>
```

The Property Value Representation

Property values as used in the invention are also formatted as pure XML code. Floating point numbers always use a dot “.” as decimal point. Certain essential XML tags must be present in all property values. These are:

<PropertyValue> the wrapper of a property value

<Name> the name of the property

<DataType> the data type of the property value (if no error occurred)

<Data> the actual data in ASCII representation (if no error occurred)

There can be any number of additional XML tags in the property value tag. The following illustrates a property value as defined using XML code (indentations are shown for better visibility, and need not appear in the final code):

<PropertyValue>
<Name>
somepropertyname
</Name>
<DataType>
float
</DataType>
<Data>
10.645
</Data>
<PropertyValue>

Where an array of values has to be transported, the values are enclosed in <A></A>tags

Property Read Request Representation

When requesting property values from the DSP kernel, the following XML tags are defined:

<PropertyRead> - wraps the query
<Name> - the name of the property that shall be queried

For example:

```
<PropertyRead>
  <Name>
    somepropertyname
  </Name>
  <Name>
    someotherpropertyname
  </Name>
</PropertyRead>
```

Note that additional tags can be added to this query also, to allow “function call with parameter”-like requests.

The Data Reception Interface

The data reception interface is an event driven interface. The DSP kernel resident on the DSP device sends data events to the Host application, Measure Foundry in our illustrative example. The data is received by the ActiveX control, and decoded, and fires or “raises” the ActiveX event OnData. This event also passes the data, and an identifier, to the event method of the host side API. The events are passed through the Windows message queue and are thus synchronous to the main task execution flow. An identifier, in the form of a readable string, is provided with every event and identifies the source of the data. The system incorporates methods to query all available data source identifiers and to filter the data sources of interest. The data can have various data types, for example including the following:

2-dimensional Arrays of Integer (signed 32 bit integer)

2-dimensional Arrays of DWord (unsigned 32 bit integer)

2-dimensional Arrays of Short (signed 16 bit integer)

2-dimensional Arrays of Word (unsigned 16 bit integer)

2-dimensional Arrays of Byte (unsigned 8 bit integer)

2-dimensional Arrays of Single (Float 32 bit)

2-dimensional Arrays of Double (Float 64 bit)

Every data packet consists of a header that describes the data structure and origin and the data itself. A typical data packet header would have the following structure:

```
Struct tagOpenDSPDataPacket
{
  WORD magic;
  WORD version;
  Char datatype[16];
  DWORD samplesperchannel;
  DWORD bytesperchannel;
  WORD channelcount;
  WORD datasourcelength;
  Char datasource[ ];
}
```

The header structure is padded to the next 8-byte boundary.

The components of the header include:

Magic—a number that identifies the following as a data packet (0x1234)

Version—the version number of the data packet header. (0x1)

Datatype—a length limited string that contains the data type in ASCII text. Allowed data types are listed below

Samplesperchannel—the length of one channel of data given in “samples”

Bytesperchannel—the length of one channel of data given in “bytes”

Channelcount—the number of channels of data

Datasourcelength—the length of the datasource string given in characters. This number of characters follows datasource.

Datasource—the string that names the data source. Zeroes are appended to the last string to pad the whole header to an 8 byte boundary. The data follows. The start of each data channel data block must be aligned to 8-byte boundaries. The data order is: {All data of the first channel}-{All data of the second channel} . . .

The allowed/supported data types may include:

“Arr single” 2-dimensional array of 32 bit floats

“Arr double”—2-dimensional array of 32 bit floats

“Arr integer”—2-dimensional array of signed 32 bit integers

“Arr DWORD”—2-dimensional array of unsigned 32 bit integers

“Arr WORD”—2-dimensional array of unsigned 16 bit integers

“Arr short”—2-dimensional array of signed 16 bit integers

“Arr byte”—2-dimensional array of unsigned 8 bit integers

Data Source Definition Transport Layer

Data source definitions are transported, as XML code, from the DSP kernel resident on the DSP device to the host application. The following tags are required for a data source definition:

<DataSourceDefinition> the data source definition wrapper

<Name> the name of the data source

<DataType> the type of data that this data source generates. See “Data reception interface” for a list of available data types

Event Reception Interface

The event reception interface is an event driven interface. The DSP kernel sends event events to the Host. The data is received by the ActiveX control, decoded and fires the ActiveX's event OnEvent.

There are methods to query all available event identifiers and to filter the events of interest. The event data is pure XML data. The required tags are:

<Event>—the wrapper of the event data

<Name>—the name of the event Optional tags are:

<Text>—additional text to further describe the event.

Any other tags may be added as needed.

### EXAMPLE

```
<Event>
  <Name>
    A/D started
  </Name>
</Event>
```

Event Definition Transport Layer

Event definitions are transported from the DSP kernel to the host application as XML code.

The following tags are required for an event definition:

<EventDefinition> the event definition wrapper

<Name> the name of the event

Data Sink Interface

It may sometimes be necessary to transport huge amounts of data rapidly from the host application to the DSP kernel. For example the user's project may require large .wav audio files (each comprising many megabytes of data) to be transported to the DSP for playback by the analog output subsystem of the DSP. In those circumstances the capabilities of the standard property interface to allow the transporting of this data may not be sufficient. A data sink interface has therefore been provided in order to provide a faster data path, and does so by sending data to a specified data sink.

There are methods to query all possible data sinks and their requirements. Data sink identifiers are readable ASCII names that the DSP kernel defines. The transport layer is very similar to the data reception interface transport layer, and, here also, supported data types may include:

2-dimensional Arrays of Integer (signed 32 bit integer)

2-dimensional Arrays of DWord (unsigned 32 bit integer)

2-dimensional Arrays of Short (signed 16 bit integer)

2-dimensional Arrays of Word (unsigned 16 bit integer)

2-dimensional Arrays of Byte (unsigned 8 bit integer)

2-dimensional Arrays of Single (Float 32 bit)

2-dimensional Arrays of Double (Float 64 bit)

Every data packet consists of a header that describes the data structure and destination and the data itself. The header structure may be:

```
Struct tagOpenDSPFastPathDataPacket
{
  WORD magic;
  WORD version;
  Char datatype[16];
  DWORD samplesperchannel;
  DWORD bytesperchannel;
  WORD channelcount;
  WORD datasinklength;
  Char datasink[ ];
}
```

The header structure is padded to the next 8-byte boundary. Components of the header:

Magic—a number that identifies the following as a data packet (0x1234)

Version—the version number of the data packet header. (0x1)

Datatype—a length limited string that contains the data type in ASCII text.

Allowed data types are listed below

Samplesperchannel—the length of one channel of data given in “samples”

Bytesperchannel—the length of one channel of data given in “bytes”

Channelcount—the number of channels of data

Datasinklength—the length of the datasink string given in characters. This number of characters follows datasink.

Datasink—the string that names the data sink. Zeroes are appended to the last string to pad the whole header to an 8 byte boundary.

The data follows.

The data order is {All data of the first channel}{All data of the second channel} . . .

Allowed/supported data types:

“Arr single”—2-dimensional array of 32 bit floats

“Arr double”—2-dimensional array of 32 bit floats

“Arr integer”—2-dimensional array of signed 32 bit integers

“Arr DWORD”—2-dimensional array of unsigned 32 bit integers

“Arr WORD”—2-dimensional array of unsigned 16 bit integers

“Arr short”—2-dimensional array of signed 16 bit integers

“Arr byte”—2-dimensional array of unsigned 8 bit integers

Data Sink Definition Transport Layer

Data sink definitions are transported from the DSP kernel to the host application as XML code. The following tags are required for a fast data path definition:

<DataSinkDefinition> the data sink definition wrapper

<Name> the name of the data sink

<DataType> the type of data that this data sink expects. See “Data sink interface” for a list of available data types

For Active OpenDSP (ActiveX Implementation)

API and Board Management Methods

Suggested “API and Board Management” methods include the following:

GetBoardNames

This method returns the names of all compatible boards in the system. The names are returned a variant array of strings.

GetBoardDefinition

This method returns the board definition of a specific board. This definition contains pure XML code that describes all capabilities of the selected DSP board and its DSP kernel.

Predefined tags are:

<BoardDefinition> wraps the definition

<Name> the name of the board

<DSPKernelVersion> the version number of the DSP kernel

<NumberOfADChannels>

<MaxADClockFrequency>

LoadOpenDSPKernel

This method loads a specified OpenDSP kernel into a specified board. If error is not empty, the operation has failed. The failure reason is provided in error.

OpenBoard

This method opens the named board for usage by this ActiveX control. An error may occur in which case the board is not opened and error is not empty. This method must be called successfully before any of the board related methods can be called.

CloseBoard

This method closes the currently opened board.

Common Methods

The “common methods” are methods common to the use of XML code generally.

GetXMLTags

This method returns a list of all XML tags in the XML code. The list is a variant array of strings.

GetXMLTag

This method extracts a specific XML tag from XML code. The isolated code only contains the “data” part between the XML tags, without the XML tags itself.

For example, if the code were:

<Name>hello</Name>

Upon use of the GetXMLTag method to extract the <Name>tag, the string _{“}hello” would be returned (without <Name> and </Name>).

GetEnumerationFromXMLTag

This method looks for the <Enumeration> tag in the XML code and reads all <Value> tags in there into a variant array of strings.

GetRangeFromXMLTag

This method looks for the <Range> tag in the XML code and reads the tags <Min>, <Max> and <Step> into the appropriate output parameters of the method. It also sets the appropriate flags in the output flags parameter to notify the presence of the specific tag.

OnDefinitionsChanged

This event is fired when definitions have changed. This may happen if the number of properties changed or enumerations have changed or if there are new data sinks or sources.

Definitionid Identifies Which Definitions Have Changed.

Possible values are:

“Properties”

“DataSources”

“DataSinks”

“Events”

Property Interface Methods

GetPropertyDefinitions

This method queries all property definitions from the DSP kernel. The definitions are returned as a string that contains the XML definitions of all properties; the method GetXMLTag can be used to isolate the tags from this definition, and, usually, at least the tags <PropertyDefinition>, <Name> and <DataType> will be isolated in this way. If the data type of the property is an enumeration, the possible enumerated values can be retrieved using the method GetEnumerationFromXMLTag. Also, the method GetRangeFromXMLTag can be used to check if the definition contains a ranged data type.

The GetPropertyDefinitions method queries the definitions from the DSP only once, and puts them in a cache for better performance; every time the namespace changes, however, the cache is invalidated. The next time this method is called, a new definition is queried from the DSP and put into the cache.

GetPropertyNames

This method returns a variant array of strings with all property names. This method uses GetPropertyDefinitions internally.

GetPropertyDefinition

This method queries the definition of the specified property for the DSP kernel. The definition is returned as a string which contains the XML definition of the named property. The method GetXML Tag can be used to isolate the tags from this definition, and, usually, at least the tags <PropertyDefinition>, <Name> and <DataType> will be isolated in this way. If the property's data type is an enumeration, the possible enumerated values can be retrieved using the method GetEnumerationFromXMLTag. Here also, the method GetRangeFromXMLTag can be used to check if the definition contains a ranged data type.

The GetPropertyDefinition method uses the GetPropertyDefinitions method internally.

SetProperty

This method sets the value of the named property. The content of the parameter value must be capable of conversion to the defined data type. Internally the content of the variant parameter is converted to an XML representation and sent down to the DSP kernel. This is done to be independent of any specific Microsoft Windows architecture. Additional XML tags may be added to the property if needed by the listening DSP kernel. The function is blocking, and returns after the value has been set in the DSP kernel and either the DSP kernel has sent an acknowledge signal or a timeout has occurred.

GetProperty

This method queries the current value of the named property. The value is returned in the defined data type. Additional XML tags may by sent to the DSP kernel, and are entered through the parameter additionalinputtags. The information is transferred in an XML representation from the DSP kernel to the host application, a format that provides flexibility for future extensions.

GetAllProperties

This method retrieves all available properties with their current values at once. The result is a string with an XML representation of the properties and their values. This string can be used to get a quick snapshot of the current set up. This string can be used with SetMultipleProperties to restore the current set up of the DSP kernel.

SetMultipleProperties

This method allows to set multiple properties at once using the XML representation of the properties and their values. This method can also be used to set up the whole DSP kernel with one command. This method is somehow the inverse of GetAllProperties.

SetPropertyCacheMode

This method sets the cache mode for property get and set operations. The property cache reduces the amount of traffic to and from the DSP kernel and speeds up operation.

FlushPropertyCache

This method writes all changes that have been made to properties to the DSP kernel. Every property change that is made when write cache is enabled is recorded. This record is sent to the DSP kernel at once when the flush method is called. If a property has been changed multiple times between adjacent flushes of the cache, multiple records of changes are stored and executed when the flush is performed.

UpdatePropertyCache

This method reads the current state of all properties from the DSP kernel into the property cache. This method is automatically performed when read cache is enabled and a namespace changed event was sent from the DSP kernel to the host to ensure that the cache at least contains the appropriate properties.

Data Interface Methods

GetDataSourceDefinitions

This method returns all currently possible data sources. “Data source” means a string that specifies a source of data. A data source only describes the origin of the data. This is especially necessary because there is only one data event for all kinds of data. The Data source allows distinguishing between the different sources of data.

Data sources could be for example:

“A/D.Buffer done”, “Math.Octave analysis”

GetDataSourceNames

This method returns a variant array of strings with all data source names. This method uses GetDataSourceDefinitions internally.

GetDataSourceDefinition

This method queries the definition of the specified data source from the DSP kernel. The definition is returned as a string. This string contains the XML definition of the named data source. The method GetXMLTag can be used to isolate the tags from this definition. Usually at least the tags <DataSourceDefinition>, <Name> and <DataType> will be isolated in this way.

This method uses the GetDataSourceDefinitions method internally.

CreateChainedDataSource

This method creates a new data source by linking an existing data source that must have link capability to a data source that generates the input data for the newly created data source.

For example, given a DSP device comprising three data sources including source “A/D”, data source “HammingWindow” and data source “FFT”, a data source chain may be created whereby data source “A/D” streams data into the data source “HammingWindow”, and data source “HammingWindow” then streams data into data source “FFT”. The final data source might be given the name A/D_HammingWindow_FFT”. This can be achieved by two calls to the CreateChainedDataSource method, as follows: Dspax.CreateChainedDataSource(“A/D”, “HammingWindow”, “A/D_HammingWindow”, error);

Dspax.CreateChainedDataSource(“A/D_HammingWindow”, “FFT”, “A/D_HammingWindow_FFT”, error);

SetDataSourceFilter

This method allows setting a filter that lets only the specified data sources pass data to this control. If no filter is set, all data sources are passed; and no data source is disabled.

OnData

This event is fired every time a data packet arrives at the host application from the DSP device. The parameters contain the source of data and the data itself. Note that if a datasource filter is set, not every data source is enabled to send data to this control. Datasource, any instance that outputs streaming data, like the analog input subsystem or any data post-processor with streaming data output (high pass, low pass, octave analysis, fft, etc.), specifies the exact origin of the data, such as, for example, “A/D.Buffer done”, or “Math.Octave analysis”. The data arrives as a variant containing a 2-dimensional array of a valid simple data type.

Event Interface Methods

GetEventDefinitions

This method queries the DSP kernel and returns all possible event definitions. An eventname is a unique string that identifies the event. This method is usually used internally.

GetEventNames

This method returns a variant array of strings with all event names. This method uses internally the GetEventDefinition method described below.

GetEventDefinition

This method queries the definition of the specified event from the DSP kernel. The definition is returned as a string. This string contains the XML definition of the named event. The method GetXMLTag can be used to isolate the tags from this definition. Usually at least the tags <EventDefinition> and <Name> will be isolated in this way. This method uses the method GetDataSourceDefinitions internally.

SetEventFilter

This method allows setting a filter that lets only the specified events pass data to this control. If no filter is set, all events are passed, and no event is disabled.

OnEvent

This event is fired every time the DSP kernel sends an event to this control. Note that if an event filter is set, not every event is enabled to send event data to this control. Eventname contains the (unique) name of the event to identify it. This name and additional information is contained in the original XML event code in xmleventcode. (See the “Event reception interface” for further information on the XML event representation.)

Data Sink Interface Methods

GetDataSinks This method returns the definitions of all available data sinks. This method is normally used internally. The definitions are returned as a string, which contains the xml definitions of all data sinks. The method GetXMLTag can be used to isolate the tags from this definition. Usually at least the tags <DataSinkDefinition>, <Name> and <DataType> will be isolated in this way. Every fast data path sink is identified by a string. The method GetDataSinkNames may be used to get a list of the available data sink identifiers. The GetDataSinkDefinition method is used to get the definition of a specific data sink.

GetDataSinkNames

This method returns a variant array of strings with all data sink names that are currently available in the DSP kernel.

GetDataSinkDefiniton

This method returns the definition of a specified data sink. The definition is returned as XML code, which usually contains at least the tags <DataSinkDefinition>, <Name> and <DataType>.

SendDataToSink

This method allows sending data to a specified data sink. The available sinks can be queried using GetDataSinks. The data needs to be of type “variant 2-dimensional array of allowed simple type” and of the type that the receiving data sink needs.

DSP Connectivity Interface

The DSP side of the interface between the DSP device and the host application is divided into 6 functional units. These six units are

1. Board management

2. Module management

3. Property handling

4. Event handling

5. Stream Data sender handling

6. Stream data receiver handling

The OpenDSP kernel is a modular system, and functional modules can be added and removed to adapt the system to customer needs. (It is advisable to define a “namespace” for each module; this is to be done by prefixing each function in a module by a unique prefix such as “fft_, “ad_” or “octa_”.)

Modularity is achieved in multiple ways. First, every module is initialized from the main initialization function. Also, in its initialization function, a module registers its own properties, data sources, events, data sinks, and data links to other data sources, as needed by the module; the module also may register board definition tags, dispatcher callback functions and message IDs. Whatever the event may be that causes a module to be activated, in the end a message must be sent to the dispatcher mailbox, and the dispatcher then calls the appropriate callback function to let the final module code get executed; thus there usually is a mailbox message generating phase and a synchronized execution phase. (There are exceptions to this rule, and, for example, a system may be constructed where a PID loop executes in an HWI and not synchronized in the main task.)

Board and Dispatcher Management

BoardRegisterDefinitionTags

This function adds board definition tags to the board definition. These tags are XML tags. This function allows modules to add definitions to the common board definitions without needing to change existing code. This function should be called in the module initialization function. On the host side, the function GetBoardDefinition reads all the registered board definitions.

Return: If the function succeeds, IF_SUCCESS is returned.

DispatcherRegisterCallback

This function adds a dispatcher callback to the dispatcher system. The dispatcher waits for a message in the dispatcher mailbox. If a message occurs in the mailbox, it checks the message id of the message. If the dispatcher finds a registered msg_id that was registered using this function, DispatcherRegisterCalback, it calls the registered callback function with the content of the message. The message id msg_id must be unique.

Return: IF_SUCCESS the function succeded

IF_MESSAGE_ID_NOT_UNIQUE the message id is already in use

Prototype for Dispatcher Callback Functions

This is the function prototype for dispatcher callback functions.

Parameters:

msg—the message that caused the function to be called by the dispatcher.

Return: IF_SUCCESS the function succeded

StatisticsRegisterSTS

This function registers an STS object in the statistics system. The statistics system also registers a property “Common.Statistics”; reading this property returns all registered STS objects in an XML code representation.

Module Management

Modules are functional units that can be added to the OpenDSP kernel. Every module may register properties, events, data sources and data sinks. There is an initialization function that must be called for each module in the OpenDSP kernel initialization function to integrate this module into the system. Likewise there is a termination function that shuts down the system. This termination function must call the termination functions of the modules.

One of the key features of the DSP connectivity interface is to provide a way to post process data sources and to create new data sources from the processed “raw” data. This is achieved by providing a “link” mechanism that allows to “link” into the data stream of any data source. ModuleRegisterDataLink allows adding a callback function to the data stream of a specified data source that gets called every time the data source emits a data buffer.

The sequence of operation is:

1. DataSourceSend function is called from data source generator

2. in DataSourceSend data is sent to the host

3. in DataSourceSend data is sent to any registered data link

4. DataSourceSend returns

This makes it necessary that the function DataSourceSend be reentrant. It can be called recursively.

Generic Module Initialization Function

This is the generic function prototype for module initialization functions. This function must be called in the system initialization function to integrate this module into the system.

Return: If the function succeeds, IF_SUCCESS is returned.

Generic Module Termination Function

This is the generic function prototype for module termination functions. This function must be called in the system termination function to integrate this module into the system.

Return: If the function succeeds, IF_SUCCESS is returned.

ModuleDataLinkClear

This function removes all links from all data sources.

Return: If the function succeeds, IF_SUCCESS is returned.

ModuleDataLinkRegister

This function allows registering a callback function that is called every time the named datasource emits a data buffer. One parameter of the callback function is the original data buffer.

Return: If the function succeeds, IF_SUCCESS is returned.

ModuleDataLinkUnRegister

This function removes a specific previous data link registration.

Return: If the function succeeds, IF_SUCCESS is returned.

Property Handling Functions

The Property Handling Functions comprise a group of API functions that deal with registering properties and getting and setting their values. The principal way to create a property is to register it using PropertyRegister. All access to a property is directed through its associated property handler function. Every property may have a different one or share one or more common property handlers.

PropertyClear

This function removes all property definitions from the property list. Return: If the function succeeds, IF_SUCCESS is returned.

PropertyRegisterSimple

This function registers a property of a simple data type.

The required parameters are:

propertyname—the (unique) name of the property

propertytype—its data type. This is a string from the list of allowed data types.

propertyhandlerfunction—a pointer to the function that handles all access to the property

Optional parameters include:

propertydescription—(optional) description of the property. A description should always be used.

extraxmicode—(optional) additional xml code that can be accessed by the host. To be used if special information must be passed to the host.

handle—a custom-defined handle that is passed to the property handler function. This handle could be used to distinguish between various properties accesses that are passed through the same handler function.

Return: If the function succeeds, IF_SUCCESS is returned.

PropertyRegisterRanged

This function registers a property of a simple data type with a limited range and granularity.

Required parameters are:

propertyname—the (unique) name of the property

propertytype—its data type. This is a string from the list of allowed data types.

propertyhandlerfunction—a pointer to the function that handles all access to the property

min—the minimum of the definition range for values of this property

max—the maximum of the definition range for values of this property

step—the smallest distance between two adjacent values (0 means step is inactive)

Optional Parameters:

propertydescription—(optional) description of the property. A description should always be used.

extraxmicode—(optional) additional xml code that can be accessed by the host. To be used if special information must be passed to the host.

handle—a custom defined handle that is passed to the property handler function. This handle could be used to distinguish between various properties accesses that are passed through the same handler function.

Return: If the function succeeds, IF_SUCCESS is returned.

PropertyRegisterEnumeration

This function registers a property of a simple data type.

Required parameters:

prop rtynam—the (unique) name of the property

pr pertytype—its data type. This is a string from the list of allowed data types.

propertyhandlerfunction—a pointer to the function that handles all access to the property.

enumeration—a string that lists all possible enumeration values in the form of their XML representation.

Optional Parameters:

propertydescription—(optional) description of the property. A description should always be used.

extraxmicode—(optional) additional xml code that can be accessed by the host. To be used if special information must be passed to the host.

handle—a custom defined handle that is passed to the property handler function. This handle could be used to distinguish between various properties accesses that are passed through the same handler function.

Return: If the function succeeds, IF_SUCCESS is returned.

The XML format employed for enumerated values is:

<Item><Value>somevalue<Nalue><Description>a description for this value</Description></Item>

For example (with indentations shown only for clarification):

```
<Item>
<Value>
  Internal trigger
  </Value>
  <Description>
    Sets triggering to internal trigger source...
  </Description>
</Item>
<Item>
  <Value>
    External trigger
</Value>
<Description>
  Set trigger to an external trigger source
</Description>
<Item>
```

PropertyUnRegister

This function removes a previously registered property.

Required parameters:

propertyname—the (unique) name of the property

Return: If the function succeeds, IF_SUCCESS is returned.

PropertiesChanged

This function notifies the Host about changes in the property definitions. The target of this function on the host side is the event OnDefinitionsChanged, with the parameter definitionid set to “Properties”.

Return: If the function succeeds, IF_SUCCESS is returned.

Prototype of “Property Handler” function

This function prototype handles access to properties.

Parameters:

handle—this is the optional handle that was passed to the PropertyRegister function.

getvalue—TRUE: the property value shall be read; FALSE: the property value shall be written

datain—if getvalue is FALSE, this string contains the XML code to write the property value. If getvalue is TRUE, this parameter has no meaning. See note below.

dataout—if getvalue is TRUE, this parameter shall receive a pointer to the XML code of the property value. If getvalue is FALSE this parameter has no meaning. The function must allocate memory for this string using memalloc. The memory is later freed by the calling function. See note for XML code.

Return: If the function succeeds, IF_SUCCESS is returned.

Note: The data is passed as XML code. The format of this code is described above in “Property value representation”. The incoming XML code in datain is the complete description as sent from the host. The outgoing data, however, is not complete; in that it does not contain the <PropertyValue> and <Name> tags. These tags are added by the calling function because this callback function may not know the name of the property with which it is associated.

The following is an example for datain content:

<PropertyValue>
<Name>
somepropertyname
</Name>
<DataType>
float
</DataType>
<Data>
10.645
</Data>
<Property Value>

Example for dataout content:

<DataType>
float
</DataType>
<Data>
10.645
</Data>

Event Handling Functions

EventClear

This function removes all event registrations from the event list.

Return: If the function succeeds, IF_SUCCESS is returned.

EventRegister

This function registers an event.

Parameters:

eventname—the (unique) name of the event

extraxmlcode—(optional) additional XML code that is passed to the host when the host queries the event definitions

Return: If the function succeeds, IF_SUCCESS is returned.

EventUnRegister

This function removes the specified event registration from the event list.

Parameters:

eventname—the (unique) name of the event

Return: If the function succeeds, IF_SUCCESS is returned.

EventFire

This function sends an event notification message to the host, and its target, on the host side, is the event OnEvent. The message consists of the standard <Name> tag that is constructed from eventname and, if available, additional XML code in extraxmlcode. Return: If the function succeeds, IF_SUCCESS is returned.

Stream Data Sender Handling Functions

Data Source Clear

This function clears the list of registered data sources.

Return: If the function succeeds, IF_SUCCESS is returned.

DataSourceRegister

This function registers a data source in the data source list.

Parameters:

datasourcename—the (unique) name of the data source.

datatype—a valid data type for the data that this data source generates.

extraxmicode—(optional) additional XML code that is passed to the host when the host queries the data source definitions

Return: If the function succeeds, IF_SUCCESS is returned.

DataSourceUnRegister

This function removes the specified data source from list of registered data sources.

Return: If the function succeeds, IF_SUCCESS is returned.

DataSourceSend

This function sends a data buffer to the host. The allocated memory for data is property of the calling function and will not be freed by DataSourceSend.

This function also deals with data links. If one or more data links have been registered for this data source, the data that is sent to DataSourceSend is also passed on to the data link callback functions.

Return: If the function succeeds, IF_SUCCESS is returned.

Stream Data Receiver Handling Functions

DataSinkClear

This function clears the list of registered data sinks.

Return: If the function succeeds, IF_SUCCESS is returned.

DataSinkRegister

This function registers a data source in the data source list.

Parameters:

datasinkname—the (unique) name of the data sink.

datatype—a valid data type for the data that this data sink can receive.

extraxmicode—(optional) additional XML code that is passed to the host when the host queries the data sink definitions.

callbackfn—this pointer points to the function that is executed when a data sink message is received for this data sink.

Return: If the function succeeds, IF_SUCCESS is returned.

DataSinkUnRegister

This function removes the specified data sink from list of registered data sinks. Return: If the function succeeds,f IF_SUCCESS is returned.

Error Handling

ActiveX errors:

Internal “property set” error message representation: Error messages may occur as a result of a property set operation. The error message is an XML code.

Certain essential tags that must be present in a property set error reply:

<Error> this tag wraps the error

<Code> this is a number that represents an error code

<Text> this is a text that describes the error in detail

<PropertyName> The name of the property that was attempted to set and caused the error.

### EXAMPLE

```
<Error>
  <PropertyName>
    somepropertyname
  </PropertyName>
  <Code>
    123
  </Cod >
  <Text>
    some error has occurred
  </Text>
<Error>
```

Host Communication Channels

For Host to DSP Communications:

Common command channel: Channel name: “HostToDSPCommand”

This channel uses XML code to describe its content.

The following commands are currently defined in the preferred embodiment of the invention:

<Command>—wraps a command. Command values are:

GetBoardDefinitions—returns the board definitions on the common return channel

GetPropertyDefinitions—returns the property definitions on the common return channel

### EXAMPLE

<Command>
GetPropertyDefinitions
</Command>

Property command channel: Channel name: “HostToDSPPropertyCommand”

The property command channel is used to send command regarding properties and their handling.

Read Property Values

The format is as defined in chapter “Property read request representation”, and repeated here:

When requesting property values from the DSP kernel, the following XML tags are used:

<PropertyRead> - wraps the query
<Name> - the name of the property that shall be queried

### EXAMPLE

```
<PropertyRead>
  <Name>
    somepropertyname
  </Name>
  <Name>
    someotherpropertyname
  </Name>
</PropertyRead>
```

Additional tags can be added to this query, to allow “function call with parameter”-like requests.

Write Property Values

The format is as defined under “Property read request representation” and repeated here: Property values are pure XML code. Floating point numbers always use a dot “.” as decimal point. Certain essential XML tags must be present in all property values. These are:

<PropertyValue> the wrapper of a property value

<Name> the name of the property

<DataType> the data type of the property value

<Data> the actual data in ASCII representation

There can be any number of additional XML tags in the property value tag.

### EXAMPLE

<PropertyValue>
<Name>
somepropertyname
</Name>
<DataType>
float
</DataType>
<Data>
10.645
</Data>
<PropertyValue>

Data sink channel: Channel name: “HostToDSPDataSink”

The used format is as defined above, under “Data sink interface”.

DSP to Host Communications

The “common return” channel: Channel name: “DSPToHostCommandReturn” This channel returns answer to commands on the HostToDSPPropertyCommand channel.

DSP Board Definitions

This definition contains pure XML code that describes all capabilities of the selected DSP board and its associated DSP kernel.

Predefined tags include:

<BoardDefinition> wraps the definition

<Name> the name of the board

<SerialNumber> the board's serial number

<DSPKernelVersion> the version number of the DSP kernel

<NumberOfADChannels>

<MaxADClockFrequency>

### EXAMPLE

```
<BoardDefinition>
  <SerialNumber>
    1234567
  </SerialNumber>
  <NumberOfADChannels>
    <Differential>
      8
    </Differential>
    <SingleEnded>
      16
    </SingleEnded>
  </NumberOfADChannels>
</BoardDefinition>
```

Property Definitions

This format is as described under “The property definition representation” and is repeated here: Property definitions are pure XML code. Certain essential XML tags must be present in all property definitions. These are:

<PropertyDefinition> wraps a property definition

<Name>specifies the name of the property. This must be unique and should be grouped into logical clusters like this “A/D.Clock Frequency”.

<DataType> the data type of this property. Possible data types today are “integer”, “float”, “string”, “enumeration” and “array of integer”, “array of float”, “array of string” and “array of enumeration”. These types can be extended in the future if needed.

<Enumeration> this tag is mandatory if the DataType is “enumeration”. It enumerates all possible values for the property. Every value is a string constant like “Internal trigger”.

Other XML tags are optional but have predefined meaning:

<Description> this tag describes the property in a few words. This tag should be used but it is not mandatory.

<Range> this tag defines a range of allowed values. For example the property “D/A.Channel0.Value” may have a value range of −10 . . . 10, because this is what the converter can deliver.

Other XML tags may be added as needed. There is no restriction on the number of additional tags, but any such additional tags must of course be capable of recognition by an application software in order to be of use.

A property is defined using XML code such as the following (with indentations shown for better visibility, which need not appear in the final code):

```
<PropertyDefinition>
<Name>
somepropertyname
</Name>
<DataType>
float
</DataType>
[optional code
<Description>
  This property is used as an example...
</Description>
<Range>
  <Min>
    −10.0
  </Min>
  <Max>
    10.0
  </Max>
  <Step>
    1.0
  </Step>
</Range>
<Emumeration>
  <Item>
    <Value>
      Internal trigger
      </Value>
      <Description>
        Sets triggering to intenal trigger source...
      </Description>
  </Item>
  <Item>
    <Value>
      External trigger
    </Value>
    <Description>
      Set trigger to an external trigger source
    </Description>
    <Item>
  </Enumeration>
  <AnyOtherTag>
    blablabla
  </AnyOtherTag>
end of the optional code]
</PropertyDefinition>
```

Property return channel: Channel name: “DSPToHostPropertyReturn” This channel returns the answer to a <PropertyRead> request. The format is as defined under “The property value representation”, repeated here: Property values are pure XML code. Floating point numbers always use a dot “.” as decimal point. Certain essential XML tags must be present in all property values. These are:

<PropertyValue> the wrapper of a property value

<Name> the name of the property

<DataType> the data type of the property value (if no error occurred)

<Data> the actual data in ASCII representation (if no error occurred)

<Error> if an error occurred this tag is present and describes the cause (if an error occurred)

<Code> this is a number that represents an error code (if an error occurred)

<Text> this is a text that describes the error in detail (if an error occurred)

There can be any number of additional XML tags in the property value tag.

A property value is defined using XML code such as the following(shown with indentations for better visibility, which need not appear in the final code):

```
<Property Value>
<Name>
somepropertyname
</Name>
<DataType>
float
</DataType>
<Data>
  10.645
</Data>
<Error>
  <Code>
    123
  </Code>
  <Text>
    some error text
  </Text>
</Error>
<PropertyValue>
```

If an array of values has to be transported, the values are enclosed in <A></A> tags

Event return channel: Channel name: “DSPToHostEventReturn”

This channel returns asynchronous event notifications. Event definitions are transported from the DSP kernel to the host as XML code. The following tags are required for an event definition:

<EventDefinition> the event definition wrapper

<Name> the name of the event

Data return channel: Channel name: “DSPToHostDataReturn”

The format of this channel is as described under “Data reception interface”.

The Code Assistant Feature

Preferably a system according to the present invention should provide means, for example a special application/property page of the ActiveX control, herein called “Code Assistant”, that allows browsing the content of the OpenDSP firmware and displaying it graphically. Provided with such means, a customer can configure the firmware according to the customer's needs. In the course of such configuration, every configuration action is recorded, and, when the configuration is complete, code can be generated for a specified supported development system. This code can then be put into the clipboard and thereafter pasted into the used development system.

Active OpenDSP is strictly code based, and no properties are stored persistently. One consequence of this approach is that it ensures the portability of the OpenDSP API to a network interface such as the Microsoft .net (Dot.net) interface. The Code Assistant GUI should be designed to enable a user to configure the OpenDSP kernel easily and rapidly.

1. A graphical DSP device programming environment adapted for integration within a windows-based host application and comprising:
(a) means for creating on a windows-based host application desktop a DSP task container panel for receiving one or more virtual panels that each represent a DSP device function and that collectively may be configured to implement a specific DSP device task;
(b) means for creating virtual panels for placement in a said DSP task container whereby each of said virtual panels represents a selected DSP device function and has a generic property page comprising means for configuring selected parameters of said selected DSP device function;
(c) means for creating and saving a file comprising a listing of descriptors that includes, for each virtual panel within a said DSP task container, descriptors of each DSP device function property page configuration selection made by a user in order to define a DSP device task implementation;
(d) translation means for translating said file into an executable DSP operating system file, comprising DSP-executable modules selected from libraries of pre-compiled binary code for executing DSP functions;
(d) means for loading said executable DSP operating system file onto a target DSP device.

2. The DSP programming environment of claim 1 wherein said means for creating a plurality of virtual panels comprises browser means for browsing a catalog of available DSP function contained in a stored DSP operating system.

3. The DSP programming environment of claim 2 wherein said catalog contains descriptions of available DSP functions set forth in eXtensible Markup Language (XML).

4. The DSP programming environment of claim 3 wherein said catalog comprises, for at least one target DSP device, an XML-based description of each functional component of said at least one target DSP device.

5. The DSP programming environment of claim 1 comprising means for creating, whenever any of said virtual panels is opened, a generic property page comprising graphical means including editor tools for enabling a user to set up selected properties of the DSP function represented by the virtual panel thus opened.

6. The DSP programming environment of claim 5 further comprising means for creating, and associating with each of said virtual panels, a file adapted to retrievably store in memory on the host application the data representing the property page values and parameters selected by a user in order to configure the DSP function associated with a said virtual panel.

7. The DSP programming environment of claim 1, further comprising a plurality of DSP task container panels each adapted to receive at least one DSP function panel and to implement a specific DSP task.

8. The DSP programming environment of claim 1, wherein said file comprising a listing of descriptors of virtual panel property page configuration selections is set forth in aspect interaction language and comprises aspect interaction language descriptors of all configured properties of all DSP function panels within a said container panel.

9. The DSP programming environment of claim 8, wherein said aspect interaction language file of descriptors comprises sufficient DSP function property configuration descriptors to define a programmed DSP task.

10. The DSP programming environment of claim 9, wherein said descriptors include data representing DSP task process identification, used pipes and their variables, needed resources, used function objects and properties of said objects, and interconnections between function objects.

11. The DSP programming environment of dependent claim 9, further comprising utility means for parsing said aspect interaction file and translating its contents into DSP-readable form.

12. The DSP programming environment of preceding claim 11 further comprising libraries of DSP-executable binaries stored as function panels, and utility means for employing said libraries to configure said DSP-readable form of said file into parameters of binary DSP modules.

13. The DSP programming environment of claim 12 wherein said libraries of DSP-executable binaries comprises pre-compiled binary modules sufficient to configure all user-programmable functions of a plurality of different DSP hardware devices.

14. The DSP programming environment of claim 1 further comprising means for creating a plurality of task-oriented, custom DSP operating systems for a plurality of different DSP hardware devices, each of said custom DSP operating systems comprising DSP-executable binaries representing a set of DSP functions configured by a user.

15. The DSP programming environment of claim 14 further comprising means for loading a said custom DSP operating system onto a selected one of a plurality of target DSP devices.

16. The DSP programming environment of claim 1 wherein said windows-based host application is a test and measurement application.

17. The DSP environment of claim 7 further comprising a DSP device panel adapted to receive and to contain a plurality of said DSP task container panels, whereby said DSP device panel may be configured to implement a plurality of DSP tasks all intended for implementation on a specific DSP device.

18. The DSP environment of claim 17 further comprising means whereby within a said DSP device panel a DSP task may be associated with at least one other DSP task.

19. The DSP environment of claim 17 whereby said DSP device panel serves as host for device global data including global variables.

20. A graphical development environment for programming DSP applications, said development environment comprising:
(a) a windows-based application builder having a graphical user interface,
(b) library files accessible by said application builder that comprise pre-compiled binary code for executing a DSP function,
(c) means for displaying on said graphical user interface a plurality of representations of DSP functions for selection by a user,
(d) means for enabling a user to select at least one DSP function represented on said graphical user interface,
(e) means for enabling a user to configure at least one property of a DSP function selected by said user,
(f) means for generating a description of a user-selected and configured DSP function, and
(g) translation means for associating a said description of a user-selected and configured DSP function with at least one library file comprising pre-compiled binary code for executing said user-selected and configured DSP function on a DSP device.
